(19) United States
(12) Patent Application Publication
(10) Pub. No.: US 2024/0257641 A1
(43) Pub. Date: Aug. 1, 2024

(54) INFORMATION PROVIDING METHOD, INFORMATION DISPLAY METHOD, AND COMPUTER PROGRAM PRODUCT

(71) Applicant: Panasonic Automotive Systems Co., Ltd., Kanagawa (JP)

(72) Inventors: Akihiko IGUCHI, Osaka Fu (JP); Fumio KOSUGE, Kanagawa Ken (JP); Shinya AIZAWA, Kanagawa Ken (JP)

(73) Assignee: Panasonic Automotive Systems Co., Ltd., Kanagawa (JP)

(21) Appl. No.: 18/630,517

(22) Filed: Apr. 9, 2024

Related U.S. Application Data
(63) Continuation of application No. PCT/JP2022/029401, filed on Jul. 29, 2022.

(30) Foreign Application Priority Data
Oct. 14, 2021 (JP) 2021-168503

(51) Int. Cl. G08G 1/14; G06V 20/52; G06V 20/56

(52) U.S. Cl. CPC G08G 1/144; G06V 20/52; G06V 20/56; G08G 1/146; G06V 2201/08

(57) ABSTRACT

An information providing method according to the present disclosure is executed in a parking lot management system including a management server that communicates with operation terminals of users and manages information related to a vehicle status in a parking lot, and includes: acquiring a first image captured by a first camera that captures an entrance of the parking lot and position/operation information indicating positions and operations of vehicles present in the parking lot; specifying an inbound vehicle moving to a parking section provided in the parking lot based on the first image; and transmitting, based on a position of the inbound vehicle and vacancy information of the parking section specified based on the position/operation information, first navigation information necessary for guiding a route to the parking section in a vacant state to an operation terminal of a user associated with registration information of a vehicle specified as the inbound vehicle.

### CROSS-REFERENCE TO RELATED APPLICATIONS

This application is a continuation of International Application No. PCT/JP2022/029401, filed on Jul. 29, 2022 which claims the benefit of priority of the prior Japanese Patent Application No. 2021-168503, filed on Oct. 14, 2021, the entire contents of which are incorporated herein by reference.

### FIELD

Embodiments described herein relate generally to an information providing method, an information display method, and a computer program product.

### BACKGROUND

Conventionally, there has been known a technique for grasping a congestion status of vehicles in a parking lot provided in a commercial facility or the like. Conventional technologies are described in JP 6086817 B2, for example.

For example, in a case where an inbound vehicle is route-guided to a parking position according to the congestion status in a parking lot, it is desirable to determine a congestion factor (whether the congestion is caused by inbound vehicles or outbound vehicles) and guide the inbound vehicle to the parking position according to the congestion factor. The same applies to the case of route-guiding the outbound vehicle to the exit.

### SUMMARY

An information providing method according to an embodiment of the present disclosure is executed in a parking lot management system including a management server that communicates with operation terminals of users and manages information related to a vehicle status in a parking lot. The method includes: acquiring a first image captured by a first camera configured to capture an entrance of the parking lot and position/operation information indicating positions and operations of vehicles present in the parking lot; specifying, among the vehicles, an inbound vehicle moving to a parking section provided in the parking lot based on the first image; and transmitting, based on a position of the inbound vehicle and vacancy information of the parking section specified based on the position/operation information, first navigation information necessary for guiding a route to the parking section in a vacant state to an operation terminal of a user associated with registration information of a vehicle specified as the inbound vehicle among the operation terminals of the users.

### BRIEF DESCRIPTION OF THE DRAWINGS

FIG. 1 is a block diagram illustrating an example of a configuration of an information processing system according to an embodiment;

FIG. 2 is a diagram illustrating a hardware configuration example of a navigation device according to the embodiment;

FIG. 3 is a view illustrating an example of an inbound navigation screen according to the embodiment;

FIG. 4 is a view illustrating an example of an outbound navigation screen according to the embodiment;

FIG. 5 is a view illustrating an example of a menu screen of in-parking-lot navigation according to the embodiment;

FIG. 6 is a view illustrating an example of a registration screen according to the embodiment;

FIG. 7 is a view illustrating an example of a car navigation connection confirmation screen according to the embodiment;

FIG. 8 is a view illustrating an example of a congestion status confirmation request screen according to the embodiment;

FIG. 9 is a view illustrating an example of a congestion status confirmation display screen according to the embodiment;

FIG. 10 is a view illustrating an example of a parking area confirmation request screen according to the embodiment;

FIG. 11 is a view illustrating an example of a parking position display screen according to the embodiment;

FIG. 12 is a view illustrating an example of a notice display screen according to the embodiment;

FIG. 13 is a diagram illustrating an example of parking lot network data according to an embodiment;

FIG. 14 is a diagram illustrating an example of a data configuration of vehicle state information according to the embodiment;

FIG. 15 is a sequence diagram illustrating an example of a procedure of information processing executed in the information processing system according to the embodiment;

FIG. 16 is a sequence diagram illustrating an example of a procedure of information processing executed in the information processing system according to the embodiment;

FIG. 17 is a sequence diagram illustrating an example of a procedure of information processing executed in the information processing system according to the embodiment;

FIG. 18 is a sequence diagram illustrating an example of a procedure of information processing executed in the information processing system according to the embodiment;

FIG. 19 is a sequence diagram illustrating an example of a procedure of information processing executed in the information processing system according to the embodiment;

FIG. 20 is a sequence diagram illustrating an example of a procedure of information processing executed in the information processing system according to the embodiment;

FIG. 21 is a flowchart illustrating an example of information processing executed in an infrastructure system according to the embodiment;

FIG. 22 is a block diagram illustrating an example of a configuration of an information processing system according to a first modification example;

FIG. 23 is a sequence diagram illustrating an example of a procedure of information processing executed in the information processing system according to the first modification example;

FIG. 24 is a sequence diagram illustrating an example of a procedure of information processing executed in the information processing system according to the first modification example;

FIG. 25 is a block diagram illustrating an example of a configuration of an information processing system according to a second modification example;

FIG. 26 is a sequence diagram illustrating an example of a procedure of information processing executed in the information processing system according to the second modification example;

FIG. 27 is a sequence diagram illustrating an example of a procedure of information processing executed in the information processing system according to the second modification example; and

FIG. 28 is a flowchart illustrating an example of information processing executed in an infrastructure system according to the second modification example.

### DETAILED DESCRIPTION

Hereinafter, embodiments of an information providing method, an information display method, and a computer program product according to the present disclosure will be described with reference to the drawings. The information providing method, the information display method, and the computer program product according to the present disclosure are implemented by an information processing system 10.

### Configuration of Information Processing System

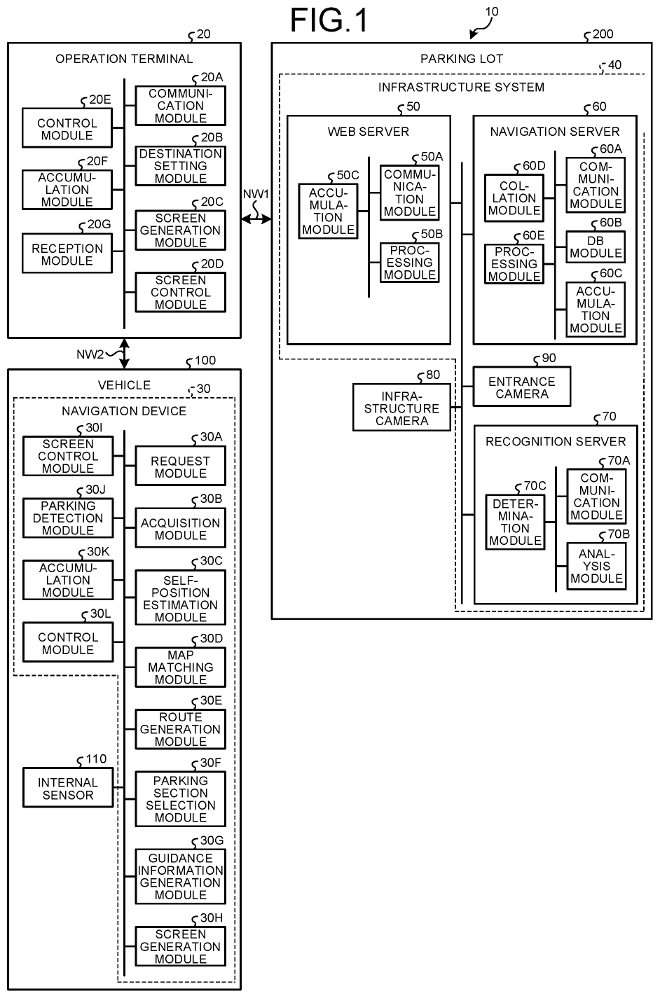

First, a configuration of the information processing system 10 according to the present embodiment will be described. FIG. 1 is a block diagram illustrating an example of a configuration of the information processing system 10 according to the embodiment.

As illustrated in FIG. 1, the information processing system 10 includes an operation terminal 20, a navigation device 30, and an infrastructure system 40. The operation terminal 20 and the infrastructure system 40 communicate with each other through a communication network NW1. The communication network NW1 is, for example, a mobile phone network having a large number of base stations as ends, a satellite communication network using communication satellites, or the like.

Further, the navigation device 30 communicates with the operation terminal 20 through a communication network NW2. The communication network NW2 is, for example, a known communication line such as Bluetooth (registered trademark). The navigation device 30 transmits and receives information to and from the infrastructure system 40 via the operation terminal 20. Note that the navigation device 30 may directly communicate with the infrastructure system 40 through the communication network NW1.

### Configuration of Navigation Device

The navigation device 30 is a device for guiding a vehicle 100 to a destination. The navigation device 30 is mounted on the vehicle 100. In addition, the navigation device 30 can communicate with the infrastructure system 40 having vacancy information indicating the vacancy state of parking sections in a parking lot 200 via the operation terminal 20.

### Hardware Configuration of Navigation Device

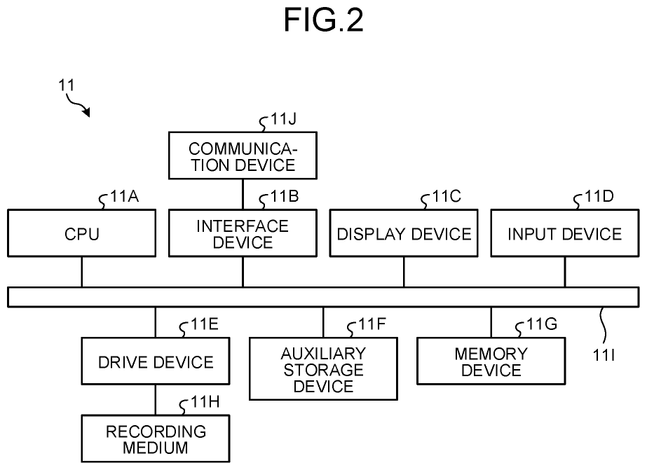

First, an example of a hardware configuration of the navigation device 30 will be described with reference to FIG. 2. The navigation device 30 includes, as hardware 11, a central processing unit (CPU) 11A, an interface device 11B, a display device 11C, an input device 11D, a drive device 11E, an auxiliary storage device 11F, a memory device 11G, and a recording medium 11H.

The CPU 11A, the interface device 11B, the display device 11C, the input device 11D, the drive device 11E, the auxiliary storage device 11F, and the memory device 11G are connected by a bus line 11I.

A program for realizing various functions of the navigation device 30 is provided by, for example, the recording medium 11H. As the recording medium 11H, a computer-readable recording medium such as a CD-ROM, a flexible disk (FD), a CD-R, and a digital versatile disk (DVD) can be appropriately used.

The drive device 11E is a device that writes information in the recording medium 11H or a device that reads information from the recording medium 11H. When the drive device 11E reads the program from the recording medium 11H, the program is installed in the auxiliary storage device 11F.

Note that the program may be downloaded from another computer via a communication network such as a local area network (LAN) or the Internet and installed in the auxiliary storage device 11F.

The auxiliary storage device 11F stores various installed programs and also stores necessary files, data, and the like. As the auxiliary storage device 11F, various storage media and storage devices such as a read only memory (ROM), a hard disk drive (HDD), a solid state drive (SSD), and a flash memory can be appropriately used.

In a case where there is an instruction to start the program, the memory device 11G temporarily stores the program read from the auxiliary storage device 11F and data used by the program. As the memory device 11G, for example, a random access memory (RAN) can be used.

The CPU 11A executes various programs stored in the memory device 11G, and implements various functions related to the navigation device 30 according to the programs.

The interface device 11B is a device that is connected to a communication device 11J and performs communication with the communication device 11J. The communication device 11J is a communication module connected to the communication network NW1 or the communication network NW2 illustrated in FIG. 1. In the navigation device 30, the communication device 11J is a communication module connected to the communication network NW2 illustrated in FIG. 1.

The display device 11C displays a graphical user interface (GUI) according to a program executed by the CPU 11A, for example. As the display device 11C, for example, a known organic electro luminescence (EL) display, a liquid crystal display, or the like can be appropriately used.

The input device 11D receives inputs of various operation instructions related to the navigation device 30 from the user of the vehicle 100 or the like. The input device 11D is, for example, at least one of an instruction input device that receives an input by a user's operation input and a microphone that receives a voice input. The instruction input device is, for example, a button, a pointing device such as a mouse or a trackball, a keyboard, or the like. The instruction input device may be a touch panel provided integrally with the display device 11C.

### Functional Configuration of Navigation Device

Returning to FIG. 1, a functional configuration of the navigation device 30 will be described. The navigation device 30 has functions as a request module 30A, an acquisition module 30B, a self-position estimation module 30C, a map matching module 30D, a route generation module 30E, a parking section selection module 30F, a guidance information generation module 30G, a screen generation module 30H, a screen control module 30I, a parking detection module 30J, an accumulation module 30K, and a control module 30L.

The request module 30A requests, from the infrastructure system 40, the parking lot network data, the vacancy information, and the floor map data regarding the parking lot 200 installed in a facility set as a destination by the user via a reception module 20G of the operation terminal 20.

The acquisition module 30B acquires the parking lot network data, the vacancy information, and the floor map data requested by the request module 30A.

The self-position estimation module 30C executes self-position estimation that is a process of estimating where the vehicle 100 is located in the parking lot network data on the basis of the information acquired from an internal sensor 110 mounted on the vehicle 100. A known method may be used as the self-position estimation method, and the self-position estimation method is not limited.

Here, the internal sensor 110 will be described. The internal sensor 110 is a sensor that is mounted on the vehicle 100 and observes information of the vehicle itself. The internal sensor 110 detects the position of the vehicle 100, the speed of the vehicle 100, the acceleration of the vehicle 100, or the like.

The internal sensor 110 is, for example, an inertial measurement unit (IMU), a speed sensor, a vehicle speed pulse, an acceleration sensor, a global positioning system (GPS) receiver, or the like. The GPS receiver receives a radio wave carrying downlink data including positioning data from a plurality of GPS satellites. The positioning data is used to detect the absolute position of the vehicle 100 from latitude, longitude information, and the like.

The internal sensor 110 transmits a sensing result to the navigation device 30 via a known communication line such as Bluetooth (registered trademark).

The map matching module 30D specifies the self-position estimated by the self-position estimation module 30C by map matching. For example, the map matching module 30D compares the traveling locus of the vehicle 100 specified based on the information acquired from the internal sensor 110 with vector data around the vehicle 100 in the parking lot network data.

Next, the map matching module 30D specifies vector data similar to the shape of the traveling locus of the vehicle 100 as an actual traveling route. Further, the map matching module 30D specifies the own vehicle position in the parking lot network data based on the specified traveling route.

The route generation module 30E generates a route from an entrance of the parking lot 200 installed in the facility to a parking section selected by the parking section selection module 30F based on the parking lot network data and the own vehicle position.

The parking section selection module 30F selects a parking section to be a destination on the basis of the parking lot network data and the vacancy information. For example, the parking section selection module 30F selects a parking section on the basis of an instruction in selecting a parking section, parking lot network data, and vacancy information received by the user via the reception module 20G of the operation terminal 20.

Note that the method of selecting a parking section is not limited to the above. For example, in a case where the navigation device 30 further includes floor map data indicating a layout of a store included in the facility as the destination, the parking section selection module 30F may select a parking section close to a store where the user is scheduled to visit on the basis of the floor map data in addition to the parking lot network data and the vacancy information.

By selecting the parking section in this way, even in a large parking lot, it is possible to smoothly move back and forth between the parking section and the space where the user is scheduled to visit. Note that the section where the user is scheduled to visit is not limited to a store, and may be an event space in the facility, an area including a plurality of stores, or the like.

In addition, the infrastructure system 40 may execute the process of selecting a parking section. In this case, the infrastructure system 40 can grasp a parking section scheduled to be parked. By treating a parking section scheduled to be parked in the same manner as a parking section in a parked state indicating a non-vacant state, it is possible to avoid a situation in which while a target vehicle 100 is moving to the selected parking section, another vehicle 100 is parked in the parking section.

The guidance information generation module 30G generates guidance information for guiding the vehicle 100 to a target parking section. Specifically, the guidance information generation module 30G generates guidance information indicating a route to the selected parking section on the basis of the parking lot network data and the own vehicle position.

The screen generation module 30H generates an image to be displayed on the display device of the navigation device 30.

The screen control module 30I outputs the image generated by the screen generation module 30H to the display device of the navigation device 30. In other words, the screen control module 30I displays the image to the user by the display device of the navigation device 30. For example, the screen control module 30I displays an inbound navigation screen and an outbound navigation screen. Note that these screens may be output to the display device of the operation terminal 20.

Here, the inbound navigation screen is an example of a display screen based on a first navigation information that guides, by the infrastructure system 40, the vehicle 100 that has entered the parking lot 200 or the user of the vehicle 100 to the position of the parking section in the vacant state. Hereinafter, the vehicle 100 that has entered the parking lot 200 is also referred to as an inbound vehicle.

In addition, the outbound navigation screen is an example of a display screen based on a second navigation information for guiding the vehicle 100 exiting a parking section of the parking lot 200 or the user of the vehicle 100 to the position of the exit of the parking lot 200. Hereinafter, the vehicle 100 exiting the parking lot 200 is also referred to as an outbound vehicle. In addition, the vehicle 100 parked in the parking section is also referred to as a parked vehicle.

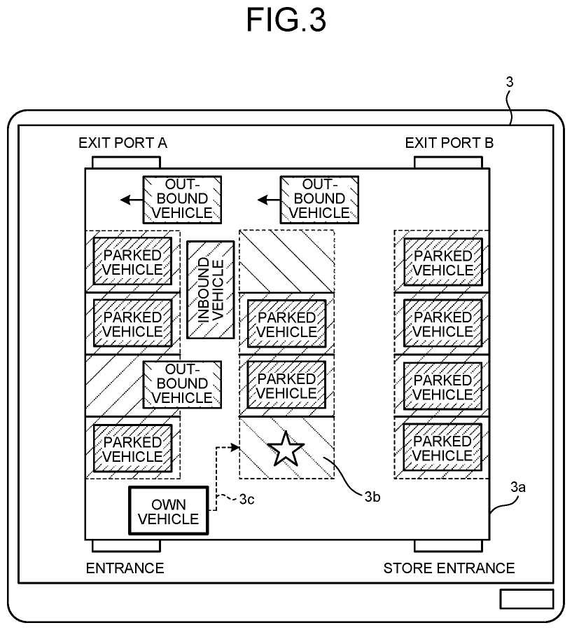

FIG. 3 is a view illustrating an example of an inbound navigation screen 3 according to the embodiment. The inbound navigation screen 3 displays, as an image, guidance information for guiding the vehicle 100 from the current location of the vehicle 100 to a specific parking section in the parking lot 200.

The inbound navigation screen 3 includes a display 3a indicating a map of the parking lot 200 including the vacancy information and the vehicle state (outbound vehicle, inbound vehicle, parked vehicle) of the vehicle staying in the parking lot 200, a display 3b of the position of the parking section selected as the destination, and a display 3c of a route from the current location of the own vehicle to the selected parking section.

When the user is about to enter the parking slot, the user can grasp the position of the vacant parking section indicating the vacant state by the display 3a. In addition, the user can determine whether the vehicle 100 staying in the parking lot 200 is the vehicle 100 about to enter, the vehicle 100 about to exit, or a parked vehicle by the display 3a.

Further, the display 3c includes an icon indicating the own vehicle. The display position of the icon indicating the own vehicle changes in real time according to the position of the own vehicle estimated by the self-position estimation module 30C.

In addition, for example, the screen control module 30I displays, as an image, guidance information for guiding the vehicle 100 from a specific parking section in the parking lot 200 in which the own vehicle 100 is parked to the exit of the parking lot 200. Note that the guidance information may be output to the display device of the operation terminal 20.

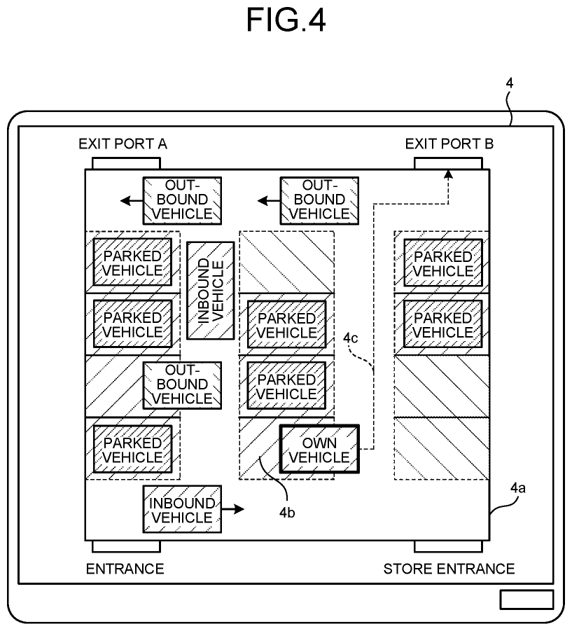

FIG. 4 is a view illustrating an example of an outbound navigation screen 4 according to the embodiment. The outbound navigation screen 4 displays, as an image, guidance information for guiding the vehicle 100 from a specific parking section in the parking lot 200 where the vehicle 100 is parked to the exit of the parking lot 200.

The outbound navigation screen 4 includes a display 4a indicating a map of the parking lot 200 including the vacancy information and the vehicle state (outbound vehicle, inbound vehicle, parked vehicle) of the vehicle staying in the parking lot 200, a display 4b indicating the position of the parking section where the own vehicle is parked, and a display 4c indicating the route from the parking section where the own vehicle is parked to the parking exit.

The user can determine whether the vehicle 100 present around the user is the vehicle 100 about to enter, the vehicle 100 about to exit, or a parked vehicle using the display 4a.

Further, the display 4c includes an icon indicating the own vehicle. The display position of the icon indicating the own vehicle changes in real time according to the position of the own vehicle estimated by the self-position estimation module 30C.

The parking detection module 30J detects that the vehicle 100 is parked in the parking section. For example, in the parking lot network data, the parking detection module 30J detects parking in a case where the own vehicle position specified by the map matching module 30D is present in the parking section selected as the destination. Note that the method of detecting parking is not limited thereto. For example, the parking detection module 30J may detect parking in a case where the vehicle 100 shifts gears into the reverse range.

The accumulation module 30K accumulates information acquired by the navigation device 30. In the present embodiment, the accumulation module 30K accumulates, for example, parking lot network data, vehicle state information, vacancy information, parking lot congestion information, exit congestion information, floor map data, store connection gate position data, and walking network data acquired from the infrastructure system 40.

The control module 30L controls the operation of each unit of the navigation device 30. For example, the control module 30L outputs the position information of the vehicle 100 at the time of detecting parking to the operation terminal 20 as parking position information.

### Configuration of Operation Terminal

The operation terminal 20 is a terminal that receives an instruction from a user. The operation terminal 20 is an example of an information display device. For example, the operation terminal 20 can be realized by a terminal such as a smartphone or a tablet terminal. In the present embodiment, an example in which a smartphone is used as the operation terminal 20 will be described.

Note that the operation terminal 20 may be directly connected to the navigation device 30 or may be connected via a network. Examples of the operation terminal 20 directly connected to the navigation device 30 include an in-vehicle display device that functions as a car navigation system. Further, the operation terminal 20 and the navigation device 30 may be integrated. That is, the operation terminal 20 may have the function of the navigation device 30.

### Hardware Configuration of Operation Terminal

First, a hardware configuration example of the operation terminal 20 will be described. The operation terminal 20 is realized by, for example, the hardware 11 of FIG. 2 described above. Note that the hardware 11 of the operation terminal 20 does not necessarily need to include the drive device 11E and the recording medium 11H. A program for realizing various functions of the operation terminal 20 is provided by being stored in advance in the auxiliary storage device 11F, for example. The CPU 11A executes various programs stored in the memory device 11G, and implements various functions related to the operation terminal 20 according to the programs.

### Functional Configuration of Operation Terminal

Returning to FIG. 1, a functional configuration of the operation terminal 20 will be described. The operation terminal 20 has functions as a communication module 20A, a destination setting module 20B, a screen generation module 20C, a screen control module 20D, a control module 20E, an accumulation module 20F, and a reception module 20G.

The communication module 20A transmits and receives information to and from the navigation device 30 and the infrastructure system 40. For example, the communication module 20A receives parking position information, which is information indicating a position where the vehicle 100 is parked, from the navigation device 30 via a known communication line such as Bluetooth (registered trademark).

The destination setting unit 20B transmits an instruction to set the parking section selected by the user as the destination to the navigation device 30 via the reception module 20G.

The screen generation module 20C generates an image to be displayed on the display device of the operation terminal 20. For example, the screen generation module 20C generates a menu screen or the like of in-parking-lot navigation which is a navigation service in a parking lot.

The screen control module 20D outputs the image generated by the screen generation module 20C to the display device of the operation terminal 20. In other words, the screen control module 20D displays the image to the user by the display device of the operation terminal 20. For example, the screen control module 20D displays the menu screen of the in-parking-lot navigation generated by the screen generation module 20C.

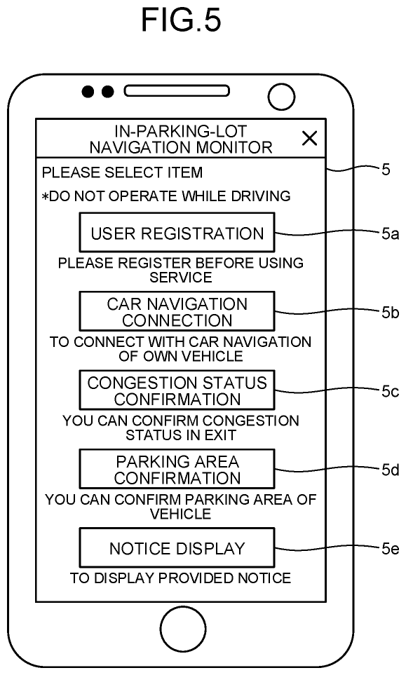

FIG. 5 is a view illustrating an example of a menu screen of in-parking-lot navigation according to the embodiment. The menu screen 5 includes a user registration button 5a, a car navigation connection button 5b, a congestion status confirmation button Sc, a parking area confirmation button 5d, and a notice display button 5e.

The user registration button 5a is a button for displaying a registration screen for performing a user registration process. The car navigation connection button 5b is a button for connecting the operation terminal 20 and the navigation device 30. The congestion status confirmation button Sc is a button for confirming the congestion status of the vehicle in the vicinity of the exit of the parking lot 200.

The parking area confirmation button 5d is a button for confirming the parking position of the own vehicle. The notice display button 5e is a button for displaying a notice notifying the user from the infrastructure system 40.

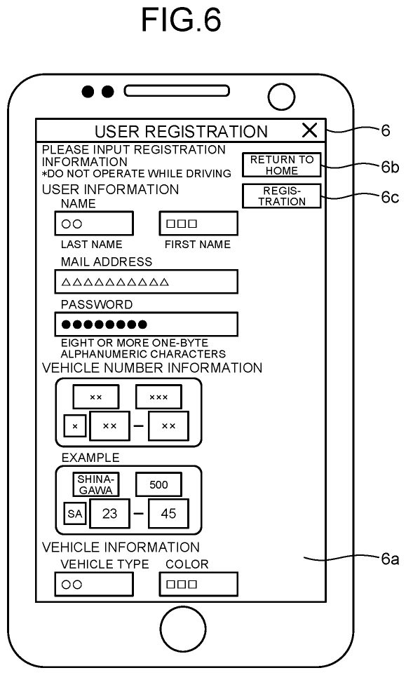

FIG. 6 is a view illustrating an example of a registration screen according to the embodiment. The registration screen 6 is a screen for performing the user registration process. The registration screen 6 is displayed when the pressing of the user registration button 5a of the menu screen 5 is received from the user. The registration screen 6 includes an input form 6a, a home button 6b, and a registration button 6c.

The input form 6a is a form for inputting user information (name, email address, password, etc.), vehicle number information, and vehicle information (vehicle type, color, etc.). The home button 6b is a button for returning to the menu screen 5. The registration button 6c is a button for transmitting the content input in the input form 6a to the infrastructure system 40 as a registration request. The infrastructure system 40 executes the user registration process based on the input content.

The user registration process is a process of storing the user information, the vehicle number information, and the vehicle information included in the registration request in the auxiliary storage device 11F of a navigation server 60 of the infrastructure system 40 as the user registration information in association with the user ID for identifying the automatically assigned user. Note that the user ID may be a mail address included in the registration request.

In a case where there is a request to use the service of the parking lot navigation, the user registration information is used to confirm that the sender of the request is a user registered as a user who can use the service of the parking lot navigation. This confirmation process is executed by the infrastructure system 40 collating the user information and the vehicle number information included in the request with the user information and the vehicle number information included in the user registration information.

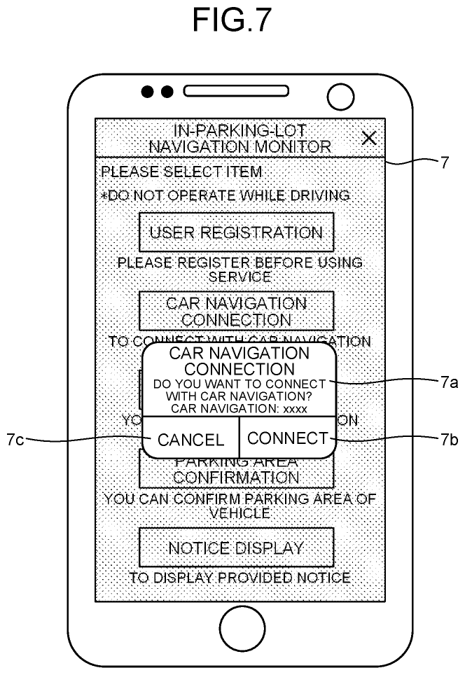

FIG. 7 is a view illustrating an example of a car navigation connection confirmation screen according to the embodiment. A car navigation connection confirmation screen 7 is a screen for connecting the operation terminal 20 and the navigation device 30. The car navigation connection confirmation screen 7 is displayed when the pressing of the car navigation connection button 5b of the menu screen 5 is received from the user.

The car navigation connection confirmation screen 7 includes a confirmation message 7a, a connection button 7b, and a cancel button 7c. The confirmation message 7a is a confirmation message indicating that the operation terminal 20 and the navigation device 30 are connected.

The connection button 7b is a button for connecting the operation terminal 20 and the navigation device 30. When receiving the pressing of the car navigation connection button 5b from the user, the operation terminal 20 and the navigation device 30 are connected by, for example, Bluetooth (registered trademark). The cancel button 7c is a button for returning to the menu screen 5.

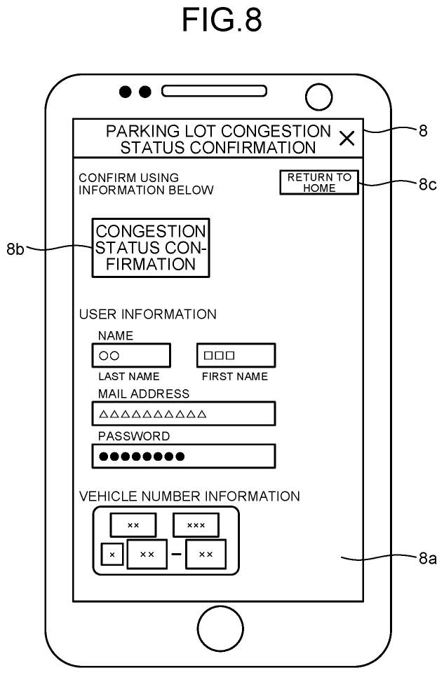

FIG. 8 is a view illustrating an example of a congestion status confirmation request screen according to the embodiment. A congestion status confirmation request screen 8 is a screen for requesting the infrastructure system 40 to confirm the congestion status. The congestion status confirmation request screen 8 is displayed when the pressing of the congestion status confirmation button Sc of the menu screen 5 is received from the user. The congestion status confirmation request screen 8 includes an input form 8a, a congestion status confirmation button 8b, and a home button 8c.

The input form 8a is a form for inputting information necessary for requesting the infrastructure system 40 to confirm the congestion status. The congestion status confirmation button 8b transmits the content input in the input form 8a to the infrastructure system 40 as a congestion status confirmation request. The home button 8c is a button for returning to the menu screen 5.

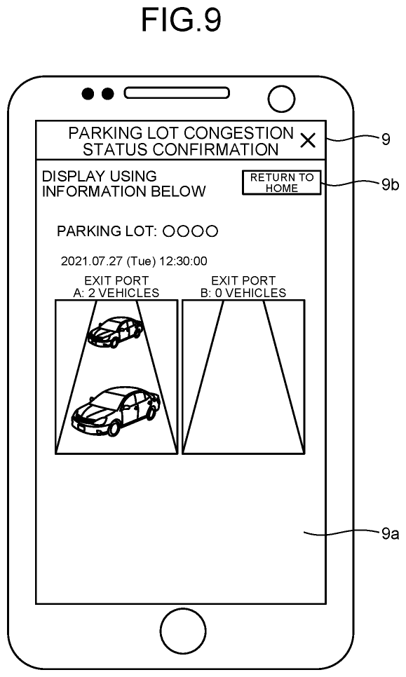

FIG. 9 is an example of the congestion status confirmation display screen according to the embodiment. The congestion status confirmation display screen 9 is a screen indicating the congestion status in the vicinity of the exit of the parking lot 200. The congestion status confirmation display screen 9 is displayed when the congestion status information transmitted from the infrastructure system 40 is received in response to the congestion status confirmation request.

The congestion status confirmation display screen 9 includes a display 9a indicating the congestion status and a home button 9b. The display 9a is an image indicating the congestion status at each exit. For example, a real-time image of the vicinity of the exit captured by an infrastructure camera 80 is displayed on the display 9a.

In addition, a detection result of the vehicle (the number of vehicles) by a recognition server 70 described later is also displayed on the display 9a. Note that the display 9a may display an image of an illustration or the like generated based on the real-time image of the vicinity of the exit captured by the infrastructure camera 80. The home button 9b is a button for returning to the menu screen 5.

Note that the congestion status confirmation display screen 9 may be displayed on the display device of the navigation device 30 together with the outbound navigation screen 4 (see FIG. 4). In this case, the display 9a of the congestion status confirmation display screen 9 can be said to be an example of a display screen based on the exit peripheral image. This allows the user to check the current status in the vicinity of the exit while moving to the exit.

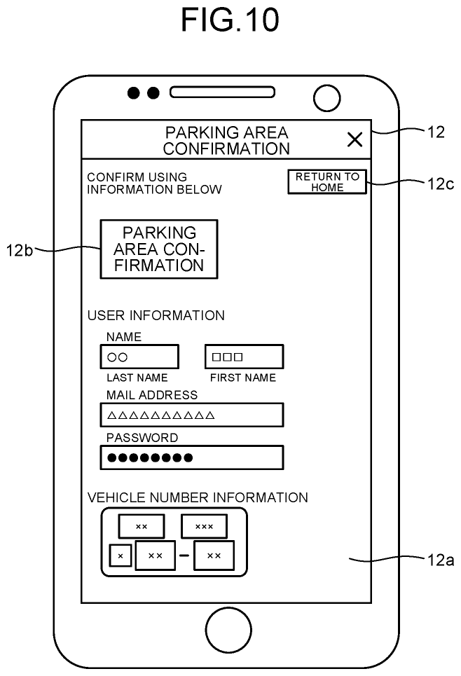

FIG. 10 is a view illustrating an example of a parking area confirmation request screen according to the embodiment. The parking area confirmation request screen 12 is a screen for requesting parking area confirmation information from the infrastructure system 40. The parking area confirmation request screen 12 is displayed when the pressing of the parking area confirmation button 5d of the menu screen 5 is received from the user. The parking area confirmation request screen 12 includes an input form 12a, a parking area confirmation button 12b, and a home button 12c.

The input form 12a is a form for inputting information necessary for requesting the parking area confirmation information from the infrastructure system 40. The parking area confirmation button 12b transmits the content input in the input form 12a to the infrastructure system 40 as a parking area confirmation request. The home button 12c is a button for returning to the menu screen 5.

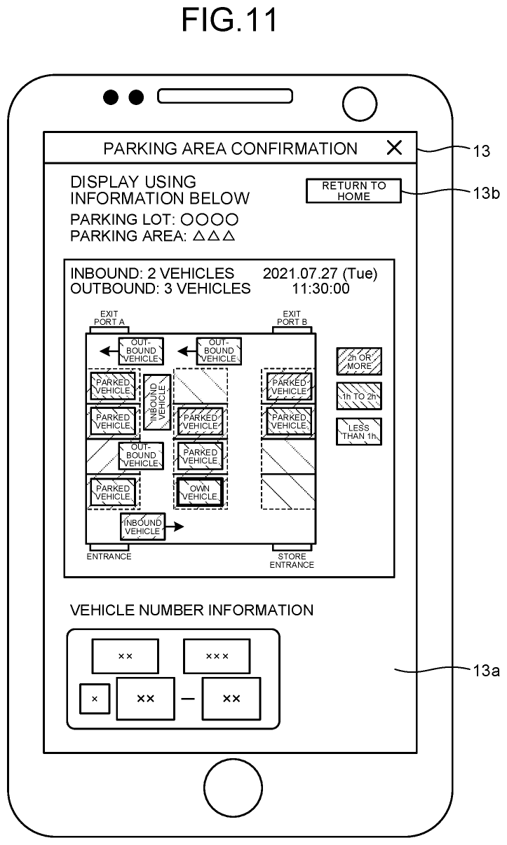

FIG. 11 is an example of a parking position display screen according to the embodiment. The parking position display screen 13 is a screen indicating the position of the parking section of the own vehicle. The parking position display screen 13 is displayed when the parking position information transmitted from the infrastructure system 40 is received in response to the parking area confirmation request.

The parking position display screen 13 includes a display 13a indicating the position of the parking section of the own vehicle and a home button 13b. The display 13a is an image indicating the position of the parking section of the own vehicle. In addition, the display 13a also includes information indicating a vehicle state (outbound vehicle, inbound vehicle, parked vehicle) of the vehicle 100 present near the parking position of the own vehicle. Further, for the parked vehicle, the parking time is also displayed. A home button 13c is a button for returning to the menu screen 5.

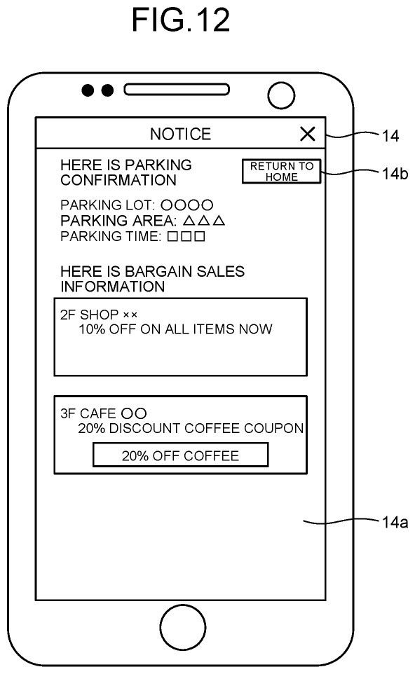

FIG. 12 is a view illustrating an example of a notice display screen according to the embodiment. A notice display screen 14 is a screen that displays information provided as notification to the user. The notice display screen 14 is displayed when the pressing of the notice display button 5e of the menu screen 5 is received from the user. The notice display screen 14 includes a display 14a for a notice and a home button 14b.

The display 14a displays the notice provided as notification to the user. Note that, in this example, information regarding stores around the parking section where the own vehicle is parked is displayed on the display 14a, but the information displayed as a notice is not limited thereto. For example, the information may be a display for providing notification that a predetermined allowable parking time is about running out, a display for providing notification that a state in which the headlight of the vehicle remains turned on is continued, or the like.

In addition, the display 14a includes a display of information indicating a parking position, parking time, and the like of the own vehicle. The home button 14b is a button for returning to the menu screen 5.

Returning to FIG. 1, the control module 20E controls each unit of the operation terminal 20. For example, the control module 20E controls the communication module 20A, the destination setting unit 20B, the screen generation module 20C, the screen control module 20D, the accumulation module 20F, and the reception module 20G based on the information acquired by the operation terminal 20.

The accumulation module 20F accumulates information acquired by the operation terminal 20. The accumulation module 20F accumulates, for example, parking position information and the like.

The reception module 20G receives an input of an instruction or information from the user. For example, the reception module 20G receives a user registration instruction or the like of the in-parking-lot navigation service via the input device 11D.

Examples of the operation terminal 20 connected to the navigation device 30 via a network include portable information terminals such as a smartphone and a tablet. Further, the operation terminal 20 and the navigation device 30 may be integrally configured.

Note that, for example, similarly to the operation terminal 20, the navigation device 30 may further have functions as a reception module that receives a user's operation and a destination setting unit that sets a destination according to the received user's operation.

### Configuration of Infrastructure System

The infrastructure system 40 is a management system for managing the parking lot 200. For example, the infrastructure system 40 is installed in a facility set as a destination by the user. The infrastructure system 40 includes a WEB server 50, a navigation server 60, a recognition server 70, an infrastructure camera 80, and an entrance camera 90.

### Configuration of WEB Server

The WEB server 50 provides information acquired from the navigation server 60 to the operation terminal 20 and the navigation device 30 via the communication network NW1. Furthermore, the WEB server 50 acquires information from the operation terminal 20 and the navigation device 30. When transmitting and receiving information to and from the navigation device 30, the WEB server 50 transmits and receives information to and from the navigation device 30 via the operation terminal 20.

### Hardware Configuration of WEB Server

A hardware configuration of the WEB server 50 is realized by, for example, the hardware 11 in FIG. 2 described above. Note that the hardware 11 of the WEB server 50 does not necessarily need to include the display device 11C and the input device 11D. The CPU 11A executes various programs stored in the memory device 11G, and implements various functions related to the WEB server 50 according to the programs.

### Functional Configuration of WEB Server

Next, a functional configuration of the WEB server 50 will be described. As illustrated in FIG. 1, the WEB server 50 has functions as a communication module 50A, a processing module 50B, and an accumulation module 50C.

The communication module 50A transmits and receives information to and from the operation terminal 20, the navigation device 30, and the navigation server 60.

For example, the communication module 50A transmits, via a known communication line such as Bluetooth (registered trademark), the vehicle state information, the vacancy information, the parking lot network data, the floor map data, the store connection gate position data, the parking lot congestion information, the exit congestion information, and the walking network data acquired from the navigation server 60 to the navigation device 30 via the operation terminal 20.

Furthermore, for example, the communication module 50A receives a registration request, a congestion status confirmation request, a parking area confirmation request, and the like from the operation terminal 20 via a known communication line such as Bluetooth (registered trademark). Furthermore, the communication module 50A transmits the registration request, the congestion status confirmation request, the parking area confirmation request, and the like via a known communication line such as Bluetooth (registered trademark) to the navigation server 60.

The processing module 50B processes information transmitted and received by the communication module 50A. For example, when transmitting the information received from the navigation server 60 to the operation terminal 20, the processing module 50B performs processing such as conversion of a data format.

The accumulation module 50C accumulates information acquired by the WEB server 50. In the present embodiment, the accumulation module 50C accumulates, for example, the vehicle state information, the vacancy information, the parking lot network data, the floor map data, the store connection gate position data, the parking lot congestion information, the exit congestion information, and the walking network data.

### Configuration of Navigation Server

The navigation server 60 acquires the vehicle state information, the vacancy information, the parking lot network data, the floor map data, the parking lot congestion information, the exit congestion information, and the walking network data updated in real time from the recognition server 70, and provides them to the WEB server 50.

### Hardware Configuration of Navigation Server

A hardware configuration of the navigation server 60 is realized by, for example, the hardware 11 in FIG. 2 described above. Note that the hardware 11 of the navigation server 60 does not necessarily need to include the display device 11C and the input device 11D. The CPU 11A executes various programs stored in the memory device 11G, and implements various functions related to the navigation server 60 according to the programs.

### Functional Configuration of Navigation Server

Next, a functional configuration of the navigation server 60 will be described. As illustrated in FIG. 1, the navigation server 60 includes functions as a communication module 60A, a database (DB) module 60B, an accumulation module 60C, a collation module 60D, and a processing module 60E.

The communication module 60A transmits and receives information to and from the WEB server 50 and the recognition server 70. For example, the communication module 60A transmits, via a known communication line such as Bluetooth (registered trademark), the vehicle state information, the vacancy information, the parking lot network data, the floor map data, the store connection gate position data, the parking lot congestion information, the exit congestion information, and the walking network data updated in real time to the WEB server 50.

The DB module 60B manages information acquired by the navigation server 60. For example, the DB module 60B manages user registration information. The DB module 60B cooperates with the accumulation module 60C to store the contents (user information, vehicle number information, and vehicle information) included in the registration request transmitted from the operation terminal 20 via the WEB server 50 in the auxiliary storage device 11F or the like as the user registration information.

The accumulation module 60C accumulates the user registration information, the vehicle state information, the vacancy information, the parking lot network data, the floor map data, the store connection gate position data, the parking lot congestion information, and the walking network data acquired by the navigation server 60.

The collation module 60D collates the user information or the like included in the request with the registered user information or the like. For example, when the communication module 60A receives the congestion status confirmation request, the collation module 60D collates the user information and the vehicle number information included in the congestion status confirmation request with the user information and the vehicle number information included in the user registration information. Even when the communication module 60A receives the parking area confirmation request, the collation module 60D executes a similar process.

By collating the user information and the like by the collation module 60D, it is possible to confirm that the operator of the operation terminal 20 that has transmitted the request is the user registered as the user of the parking lot navigation.

The processing module 60E processes various types of information. For example, the processing module 60E cooperates with the accumulation module 60C to store, in the auxiliary storage device 11F, the vehicle state information, the vacancy information, the parking lot network data, the floor map data, the store connection gate position data, the parking lot congestion information, the exit congestion information, the walking network data, and the like transmitted from the recognition server 70 in real time, thereby performing processing of updating these pieces of information.

Furthermore, for example, in a case where the communication module 60A receives the congestion status confirmation request and the collation results by the collation module 60D match each other, the processing module 60E generates congestion status information corresponding to the user information and the vehicle number information included in the congestion status confirmation request.

In this case, first, the processing module 60E specifies a parking area where the vehicle 100 of the target user is parked from the vehicle state information. Next, the processing module 60E specifies an exit available to the vehicle 100 of the user who has transmitted the congestion status confirmation request from the specified parking area and parking lot network data. Then, the processing module 60E generates congestion status information based on the specified available exit and exit congestion information.

Furthermore, for example, in a case where the communication module 60A receives the parking area confirmation request and the collation results by the collation module 60D match, the processing module 60E generates parking position information corresponding to the user information and the vehicle number information included in the parking area confirmation request.

In this case, first, the processing module 60E specifies a parking section where the vehicle 100 of the target user is parked from the vehicle state information and the parking lot network data. Next, the processing module 60E acquires information of the vehicle 100 around the specified parking section from the vehicle state information and the parking lot network data. Then, the processing module 60E generates parking position information on based on the information on the specified parking section and the information on the vehicle 100 around the specified parking section.

Furthermore, for example, the processing module 60E generates notice information for notifying the user of information. Note that the notice information is generated when conditions such as a case where the vehicle 100 is parked in a specific parking section, a case where the parking time of the vehicle 100 exceeds a predetermined time, and a case where it is detected that the headlight of the vehicle 100 continues to be turned on for more than a predetermined time are satisfied. Whether or not these conditions are satisfied can be determined, for example, by analyzing the captured image captured by the infrastructure camera 80.

### Configuration of Recognition Server

The recognition server 70 updates information such as user registration information, vehicle state information, vacancy information, parking lot congestion information, and exit congestion information in real time, and transmits the updated information to the navigation server 60.

### Hardware Configuration of Recognition Server

A hardware configuration of the recognition server 70 is realized by, for example, the hardware 11 in FIG. 2 described above. Note that the hardware 11 of the recognition server 70 does not necessarily need to include the display device 11C and the input device 11D. The CPU 11A executes various programs stored in the memory device 11G, and implements various functions related to the recognition server 70 according to the programs.

### Functional Configuration of Recognition Server

Returning to FIG. 1, a functional configuration of the recognition server will be described. The recognition server 70 has functions as a communication module 70A, an analysis module 70B, and a determination module 70C.

The communication module 70A transmits and receives information to and from the navigation server 60, the infrastructure camera 80, and the entrance camera 90. For example, the communication module 70A receives a vehicle image captured by the infrastructure camera 80 and the entrance camera 90 via a known communication line such as Bluetooth (registered trademark).

In addition, the communication module 70A transmits, via a known communication line such as Bluetooth (registered trademark), the vehicle state information, the vacancy information, the parking lot network data, the floor map data, the store connection gate position data, the parking lot congestion information, the exit congestion information, and the walking network data to the navigation server 60.

The analysis module 70B analyzes the vehicle image. The analysis module 70B analyzes the vehicle image captured by the infrastructure camera 80 and the entrance camera 90 provided in the parking lot 200. Note that a camera ID to be described later is attached to the vehicle image, and the analysis module 70B performs analysis including the camera ID. The analysis module 70B acquires various types of information on the basis of the analysis result. In addition, the analysis module 70B analyzes the vehicle image in real time and acquires various types of information in real time.

For example, the analysis module 70B acquires information such as a vehicle number, a vehicle type, and a color of the vehicle 100 from an analysis result of the vehicle image captured by the entrance camera 90. Furthermore, for example, the analysis module 70B detects whether or not each parking section is vacant from the analysis result of the vehicle image, and acquires the vacancy information.

Furthermore, for example, the analysis module 70B detects the position of the vehicle 100 traveling on the roadway in the parking lot 200 from the analysis result of the vehicle image. Note that the analysis module 70B can also detect the operation of the vehicle 100 by continuously acquiring and analyzing the vehicle image. The analysis module 70B acquires the parking lot congestion information indicating the congestion status of the parking lot 200 to be generated based on the detected position and operation of the vehicle 100 and the determination result of the vehicle state by the determination module 70C to be described later.

Furthermore, for example, the analysis module 70B detects the position and operation of the vehicle 100 staying in the vicinity of the exit in the parking lot 200 from the analysis result of the vehicle image. The analysis module 70B acquires the exit congestion information indicating the congestion status around the exit of the parking lot 200 to be generated based on the detected position and operation of the vehicle 100 and the determination result of the vehicle state by the determination module 70C to be described later.

Note that, as illustrated in FIG. 9, the exit congestion information includes information on the number of vehicles 100 staying in the vicinity of the exit detected by the analysis module 70B by analyzing the vehicle image.

Based on the vehicle image captured by the entrance camera 90 or the position and operation of the vehicle 100 in the parking lot 200, the determination module 70C determines whether the vehicle 100 is an inbound vehicle moving to a parking section provided in the parking lot or an outbound vehicle heading from the parking section to the exit of the parking lot 200 as the vehicle state.

Here, the vehicle state is information indicating whether the vehicle 100 present in the parking lot 200 is an inbound vehicle, a parked vehicle, or an outbound vehicle. An inbound vehicle refers to a state of the vehicle 100 that has entered the parking lot 200 and has not yet been parked in a parking section. Here, a vehicle in the state of an inbound vehicle is also simply referred to as an “inbound vehicle”.

In addition, a parked vehicle refers to a state of the vehicle 100 parked in the parking section. Here, a vehicle in the state of a parked vehicle is also simply referred to as a “parked vehicle”. The outbound vehicle refers to a state of the vehicle 100 moving toward the exit of the parking lot 200. Here, a vehicle in the state of an outbound vehicle is also simply referred to as an “outbound vehicle”. Note that the vehicle state of the vehicle 100 that is not present in the parking lot 200 is an undefined state.

Specifically, when the vehicle image captured by the infrastructure camera 80 or the entrance camera 90 is received by the communication module 70A, the determination module 70C determines the vehicle state of the vehicle 100 included in the vehicle image. For example, the determination module 70C determines that the vehicle state of vehicle 100 included in the vehicle image captured by entrance camera 90 is the inbound vehicle.

In addition, the determination module 70C determines, among the vehicles 100 included in the vehicle image captured by the infrastructure camera 80, a vehicle 100 that has been detected to be in a stopped state in the parking section by the analysis of the vehicle image by the analysis module 70B and has been in a stopped state for more than a predetermined time as a parked vehicle. In addition, the determination module 70C determines, among the vehicles 100 included in the vehicle image captured by the infrastructure camera 80, a vehicle 100 whose movement from the parking section has been detected by the analysis of the vehicle image by the analysis module 70B as an outbound vehicle.

In addition, the determination module 70C determines, among the vehicles 100 included in the vehicle image captured by the infrastructure camera 80, a vehicle 100 whose exit has been detected by the analysis of the vehicle image by the analysis module 70B as an undefined vehicle.

The determination result of the vehicle state by the determination module 70C is acquired by the analysis module 70B. The acquired determination result of the vehicle state is stored as vehicle state information together with the vehicle number information, and is also used for generation of parking lot congestion information and exit congestion information by the analysis module 70B. Hereinafter, a generation process of the parking lot congestion information and the exit congestion information by the analysis module 70B will be described.

First, the generation process of parking lot congestion information will be described. The analysis module 70B acquires information on the position and operation of each vehicle 100 present in the parking lot 200 detected by analysis of the vehicle image. Next, the analysis module 70B acquires the determination result of the vehicle state by the determination module 70C.

Next, the analysis module 70B acquires the position and the number of vehicles 100 determined to be inbound vehicles based on the information on the position and the operation of each vehicle 100 present in the parking lot 200 and the determination result of the vehicle state by the determination module 70C. Similarly, the analysis module 70B acquires the position and the number of vehicles 100 determined to be parked vehicles and the position and the number of vehicles 100 determined to be outbound vehicles.

Then, the analysis module 70B calculates the congestion status of the parking lot 200 for each vehicle state (inbound vehicle, parked vehicle, and outbound vehicle) based on the position and the number of the vehicles 100 determined to be the inbound vehicles, the position and the number of the vehicles 100 determined to be the parked vehicles, and the position and the number of the vehicles 100 determined to be the outbound vehicles. The analysis module 70B generates parking lot congestion information indicating a congestion status of roadways in the parking lot 200 based on the calculated congestion status of the parking lot 200 for each vehicle state.

Next, the exit congestion information will be described. The analysis module 70B acquires information on the position and operation of each vehicle 100 present in the parking lot 200 detected by analysis of the vehicle image. In addition, the analysis module 70B acquires information on the position of each vehicle 100 present in the vicinity of the exit of the parking lot 200 based on the information on the position of each vehicle 100 present in the parking lot 200. Next, the analysis module 70B acquires the determination result of the vehicle state by the determination module 70C.

Next, the analysis module 70B acquires the position and the number of vehicles 100 determined to be outbound vehicles among the vehicles 100 present in the vicinity of the exit of the parking lot 200 based on the information on the position of each vehicle 100 present in the vicinity of the exit of the parking lot 200 and the determination result of the vehicle state by the determination module 70C.

Then, the analysis module 70B calculates the congestion status in the vicinity of the exit of the parking lot 200 based on the position and the number of vehicles 100 determined as outbound vehicles among the vehicles 100 present in the vicinity of the exit of the parking lot 200. The analysis module 70B generates parking lot congestion information indicating a congestion status of the vicinity of the exit in the parking lot 200 based on the calculated congestion status of the vicinity of the exit in the parking lot 200 for each vehicle state.

### Configuration of Infrastructure Camera

The infrastructure camera 80 is an example of the second camera. The infrastructure camera 80 is an imaging device that images the parking lot 200. For example, the infrastructure camera 80 images parking sections and roadways in the parking lot 200, and acquires in-parking-lot image data as a captured image. The in-parking-lot image data is an example of the second image. The infrastructure camera 80 is a digital camera, a stereo camera, or the like.

The in-parking-lot image data is digital image data in which a pixel value is defined for each pixel. Note that the vehicle image refers to an image of the vehicle 100 in a case where the image of the vehicle 100 is included in the in-parking-lot image data. The installation position and the angle of view of the infrastructure camera 80 are adjusted in advance so that each position in the parking lot 200 can be imaged. In the present embodiment, a plurality of infrastructure cameras 80 having different imaging directions are provided in the parking lot 200.

Each of the infrastructure camera 80 includes a camera ID for identifying the infrastructure camera 80. As a result, the position of the infrastructure camera 80 can be specified based on the camera ID, and the vehicle position of the vehicle 100 in the parking lot 200 can be grasped from the position in the vehicle image captured by the infrastructure camera 80. In addition, by continuously acquiring the vehicle images, the infrastructure system 40 can also grasp the operation of the vehicle 100 in the parking lot 200. Therefore, it can be said that the plurality of pieces of in-parking-lot image data is an example of the position/operation information.

### Configuration of Entrance Camera

The entrance camera 90 is an example of the first camera. The entrance camera 90 is an imaging device that images an entrance of the parking lot 200. For example, the entrance camera 90 captures an entrance of the parking lot 200, and acquires entrance image data as a captured image. The entrance image data is an example of the first image. The entrance camera 90 is a digital camera, a stereo camera, or the like.

The entrance image data is digital image data in which a pixel value is defined for each pixel. Note that the vehicle image refers to an image of the vehicle 100 in a case where the image of the vehicle 100 is included in the entrance image data. The installation position and the angle of view of the entrance camera 90 are adjusted in advance such that the number of the vehicle 100 that has entered the parking lot 200 and the entire image of the vehicle 100 can be captured.

Note that a plurality of entrance cameras 90 having different imaging directions may be provided at the entrance of the parking lot 200. Similarly to the infrastructure camera 80, the entrance camera 90 also has a camera ID for identifying the entrance camera 90.

### Information Acquired by Information Processing System 10

Next, information used in the information processing system 10 will be described.

### Parking Lot Network Data

The parking lot network data is information used to set a route to a parking section serving as a destination in the parking lot 200 installed in a facility set as a destination by the user. The parking lot network data holds various types of information regarding parking sections and roadways in the parking lot 200 as attributes.

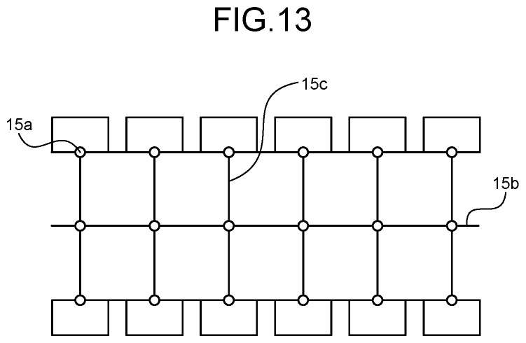

FIG. 13 is a diagram illustrating an example of parking lot network data according to an embodiment. For example, as illustrated in FIG. 13, the parking lot network data includes a parking link 15b which is vector data connecting parking points 15a indicating the respective parking sections in the parking lot 200 and a lane link 15c which is vector data indicating a roadway in the parking lot 200.

The parking lot network data may be stored in the accumulation module 30K of the navigation device 30 or may be stored in the accumulation module 60C of the navigation server 60. In a case where the parking lot network data is stored in the accumulation module 30K of the navigation device 30, the acquisition module 30B acquires the parking lot network data from the accumulation module 30K in response to the request for the parking lot network data by the request module 30A.

### Vacancy Information

The vacancy information is information indicating a vacancy state of each parking section provided in the parking lot 200. In the present embodiment, the analysis module 70B of the recognition server analyzes the image captured by the infrastructure camera 80 provided in the parking lot 200 and detects whether or not the parking section is vacant, thereby updating the vacancy information in real time. The means for acquiring the vacancy state of the parking section is not limited to the infrastructure camera 80, and the vacancy state may be acquired using a sensor capable of detecting the vehicle.

### Vehicle State Information

The vehicle state information is information indicating a vehicle state of the vehicle 100 present in the parking lot 200. In the present embodiment, the analysis module 70B of the recognition server 70 analyzes the image captured by the infrastructure camera 80 provided in the parking lot 200. Next, the determination module 70C determines whether or not the target vehicle 100 is an inbound vehicle, a parked vehicle, or an outbound vehicle based on the analysis result. The analysis module 70B acquires a vehicle state as a determination result by the determination module 70C.

The vehicle state acquired by the analysis module 70B is transmitted to the navigation server 60 in real time as vehicle state information together with information such as a vehicle position acquired by analysis of the vehicle image by the analysis module 70B. Then, the processing module 60E of the navigation server 60 cooperates with the accumulation module 60C to store the received vehicle state information in the auxiliary storage device 11F. As a result, the processing module 60E updates the vehicle state information in real time.

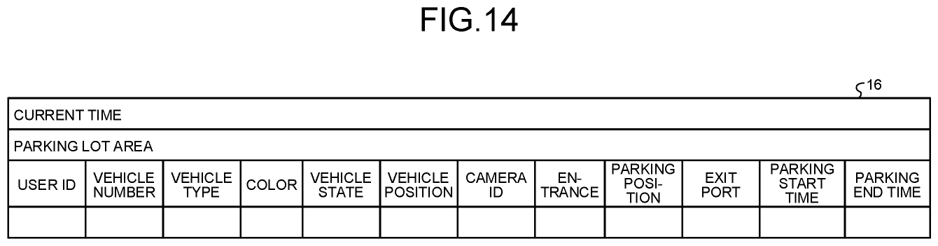

FIG. 14 is a diagram illustrating an example of a data configuration of the vehicle state information according to the embodiment. In the example of FIG. 14, vehicle state information 16 is data in which the current time, the parking lot area, the user ID, the vehicle number, the vehicle type, the color, the vehicle state, the vehicle position, the camera ID, the entrance, the parking position, the exit port, the parking start time, and the parking end time are stored in association with each other.

The current time is information indicating the time present. The parking lot area is information indicating an area where the target vehicle 100 stays in a case where the parking lot is divided into a plurality of areas. The parking lot area is represented as, for example, an A area, a B area, or the like. The user ID is information for identifying a user of the in-parking-lot navigation system. The user ID is specified based on the vehicle number captured by the entrance camera 90.

Specifically, the communication module 70A receives the vehicle image including the vehicle number from the entrance camera 90, and the analysis module 70B analyzes the vehicle image to acquire the vehicle number. The analysis module 70B refers to the user registration information and specifies the user ID associated with the vehicle number as the user ID of the user of the target vehicle 100. Note that the user ID is blank for the vehicle 100 not registered in the in-parking-lot navigation system.

The vehicle number is information indicating the number of the target vehicle 100. The vehicle number is acquired from the vehicle image captured by the entrance camera 90 as described above. The vehicle type is information indicating the type of the target vehicle 100. The color is information indicating the color of the target vehicle 100. The vehicle type and the color are specified by referring to the user registration information.

Specifically, the analysis module 70B refers to the user registration information and specifies the vehicle type and color associated with the vehicle number as the vehicle type and color of the target vehicle 100. For the unregistered vehicle 100, the analysis module 70B analyzes the vehicle image of the target vehicle 100 to acquire the vehicle type and color of the target vehicle 100.

The vehicle state is information indicating whether the target vehicle 100 is an inbound vehicle, a parked vehicle, or an outbound vehicle. The vehicle state is a determination result of the vehicle state by the determination module 70C. Additionally, it can be said that the inbound vehicle and the outbound vehicle represents the operation of the vehicle, and thus the vehicle state is an example of the operation of the vehicle.

The entrance is information indicating which entrance is used to enter the parking lot 200 in a case where there are a plurality of entrances. The entrance is acquired by analyzing the vehicle image by the analysis module 70B.

The vehicle position is information indicating the position of the target vehicle 100 in the parking lot 200. The vehicle position is acquired by analyzing the vehicle image by the analysis module 70B. The camera ID is information indicating identification information for identifying the infrastructure camera 80 or the entrance camera 90 that has captured the vehicle image of the target vehicle 100. Note that the infrastructure camera 80 or the entrance camera 90 transmits the vehicle image to the recognition server 70 with a camera ID for identifying itself. This is the camera ID of the vehicle state information.

The parking position is information indicating a parking section where the target vehicle 100 is parked if the target vehicle 100 is a parked vehicle. The parking section is acquired by analyzing the vehicle image by the analysis module 70B. The exit port is information indicating an exit from which the target vehicle 100 exits if there is a plurality of exits. The exit port is acquired by analyzing the vehicle image by the analysis module 70B.

Note that the reception module 20G of the operation terminal 20 may receive the setting of the exit through which the user desires to exit, and the recognition server 70 may acquire the exit information on the basis of the setting. In this case, the exit port can be grasped from the start of exiting the parking lot.

The parking start time is information indicating the time when the target vehicle 100 has started parking. The parking start timing is acquired by analyzing the vehicle image by the analysis module 70B. The parking end time is information indicating the time when the target vehicle 100 has started exiting. The parking end time is acquired by analyzing the vehicle image by the analysis module 70B.

### Parking Lot Congestion Information

The parking lot congestion information is information indicating a congestion status of roadways in the parking lot 200. Note that as described above, the parking lot congestion information includes information of the congestion status of the parking lot calculated for each vehicle state based on the position and the number of the vehicles 100 determined to be inbound vehicles, the position and the number of the vehicles 100 determined to be parked vehicles, and the position and the number of the vehicles 100 determined to be outbound vehicles.

In the present embodiment, the analysis module 70B analyzes the image captured by the infrastructure camera 80 provided in the parking lot 200. The analysis module 70B acquires the parking lot congestion information by detecting the position of the vehicle 100 traveling on the roadway in the parking lot 200. The parking lot congestion information is acquired in real time by the analysis module 70B.

The acquired parking lot congestion information is transmitted to the navigation server 60 by the communication module 70A. Then, the processing module 60E of the navigation server 60 cooperates with the accumulation module 60C to store the received parking lot congestion information in the auxiliary storage device 11F. As a result, the processing module 60E updates the parking lot congestion information in real time.

The means for detecting the position of the vehicle 100 is not limited to the infrastructure camera 80. For example, the position of the vehicle 100 may be detected using a sensor or the like capable of detecting the vehicle 100.

### Exit Congestion Information

The exit congestion information is information indicating a congestion status in the vicinity of the exit in the parking lot 200. Note that, as described above, the exit congestion information includes information on the congestion status of the outbound vehicle present in the vicinity of the exit of the parking lot calculated based on the position and the number of vehicles 100 determined as outbound vehicles.

In the present embodiment, the analysis module 70B analyzes the image captured by the infrastructure camera 80 provided in the parking lot 200. The analysis module 70B acquires the exit congestion information by detecting the position of the vehicle 100 staying in the vicinity of the exit of the parking lot 200.

The vicinity of the exit is a region around the exit of the parking lot 200 determined in advance. The exit congestion information is acquired in real time by the analysis module 70B. If there are a plurality of exits of the parking lot 200, exit congestion information is acquired for each exit by analyzing the vehicle image of the analysis module 70B.

The acquired exit congestion information is transmitted to the navigation server 60 by the communication module 70A. Then, the processing module 60E of the navigation server 60 cooperates with the accumulation module 60C to store the received exit congestion information in the auxiliary storage device 11F. As a result, the processing module 60E updates the exit congestion information in real time.

### Floor Map Data

The floor map data is information indicating a layout of a store included in a facility set as a destination by the user. The floor map data may be stored in the accumulation module 30K of the navigation device 30 or may be stored in the accumulation module 60C of the navigation server 60.

### Store Connection Gate Position Data

The store connection gate position data is information indicating the position of the connection gate between the facility set as the destination by the user and the parking lot 200 installed in the facility. The store connection gate position data may be stored in the accumulation module 30K of the navigation device 30 or may be stored in the accumulation module 60C of the navigation server 60.

### Walking Network Data

The walking network data is information used to set and display a route that allow to move from a parking section of the parking lot 200 to a store set as a destination by the user in the shortest distance or the shortest time.

The walking network data holds, for example, various types of information regarding parking sections and roadways in the parking lot 200 and various types of information regarding a layout of a store included in a facility set as a destination as attributes and a store connection gate position. The walking network data may be stored in the accumulation module 30K of the navigation device 30 or may be stored in the accumulation module 60C of the navigation server 60.

### Processing Procedure of Information Processing System

Next, a procedure of information processing executed in the information processing system 10 will be described. First, an inbound navigation process for guiding the inbound vehicle to a specific parking section will be described.

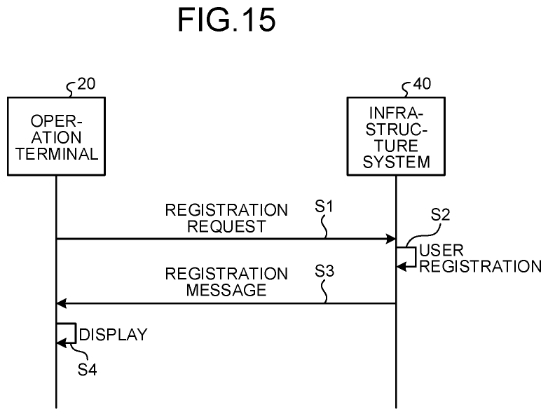

FIG. 15 is a sequence diagram illustrating an example of a procedure of information processing executed in the information processing system 10 according to the embodiment. Note that, as a premise of this process, it is assumed that the user inputs the user information, the vehicle number information, and the vehicle information in the input form 6a of the registration screen 6 (see FIG. 6) displayed on the display device of the operation terminal 20, and presses the registration button 6c.

First, the communication module 20A of the operation terminal 20 transmits a registration request to the infrastructure system 40 (Step S1). The registration request includes user information, vehicle number information, and vehicle information.

The communication module 50A of the WEB server 50 of the infrastructure system 40 receives the registration request. The communication module 50A transmits the registration request received from the operation terminal 20 to the navigation server 60. The communication module 60A of the navigation server 60 receives the registration request.

The DB module 60B executes user registration of the in-parking-lot navigation system on the basis of the user information, the vehicle number information, and the vehicle information included in the registration request (Step S2). Specifically, the DB module 60B cooperates with the accumulation module 60C to store the user ID for identifying the user, the user information, the vehicle number information, and the vehicle information in association with each other in the auxiliary storage device 11F as the user registration information. Note that the user ID is automatically set by the DB module 60B so as not to overlap.

Next, the processing module 60E generates a registration message for notifying the user that the registration is completed. The communication module 60A transmits the registration message to the WEB server 50. Next, the communication module 50A of the WEB server 50 transmits the registration message to the operation terminal 20 (Step S3). Next, the screen generation module 20C of the operation terminal 20 generates a screen displaying the registration message. Then, the screen control module 20D displays the screen for displaying the registration message on the display device of the operation terminal 20, and ends this process (Step S4).

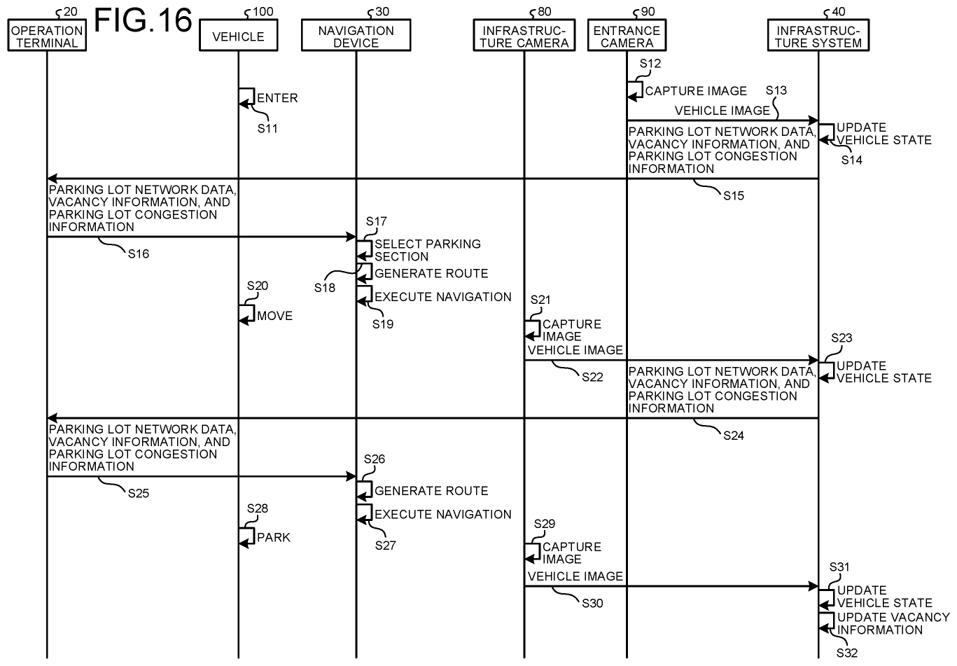

Next, the inbound navigation process for guiding the inbound vehicle to a specific parking section will be described. FIG. 16 is a sequence diagram illustrating an example of a procedure of information processing executed in the information processing system 10 according to the embodiment. Note that, as a premise of the present process, it is assumed that user information of the vehicle 100 (user) using the information processing system 10 has been registered.

First, the vehicle 100 enters the parking lot 200 (Step S11). The entrance camera 90 captures a vehicle image of the vehicle 100 that has entered (Step S12). Here, the vehicle image includes an image obtained by capturing the vehicle number of the vehicle 100 that has entered.

The entrance camera 90 transmits the vehicle image to the infrastructure system 40 (Step S13). Note that a camera ID for identifying the entrance camera 90 is attached to the vehicle image. A communication module 70A of the recognition server 70 of the infrastructure system 40 receives the vehicle image to which the camera ID is attached.

Next, the analysis module 70B analyzes the vehicle image and acquires vehicle state information. Specifically, the analysis module 70B analyzes the vehicle image received from the entrance camera 90. The analysis module 70B acquires the vehicle number of the target vehicle 100 from the analysis result. Next, the analysis module 70B refers to the user registration information of the navigation server 60 and specifies the user ID and the vehicle information (vehicle type, color, etc.) corresponding to the acquired vehicle number.

In addition, the analysis module 70B acquires, from the analysis result, information on the entrance indicating the entrance through which the target vehicle 100 has entered the parking lot 200. In addition, the analysis module 70B acquires information on the vehicle position from the analysis result. In addition, since the vehicle image of the target vehicle 100 is captured by the entrance camera 90, the determination module 70C determines the vehicle state of the target vehicle as an inbound vehicle.

The communication module 70A transmits information of the current time, the user ID, the vehicle number, the vehicle type, the color, the vehicle state, the vehicle position, the camera ID, and the entrance acquired by the analysis module 70B, the determination module 70C, and the like in association with each other to the navigation server 60 as vehicle state information. The communication module 60A of the navigation server 60 receives the vehicle state information.

The processing module 60E cooperates with the accumulation module 60C to store the received vehicle state information in the auxiliary storage device 11F, thereby updating the vehicle state information (Step S14). The communication module 60A transmits information such as the parking lot network data, the vacancy information, and the parking lot congestion information to the WEB server 50. The communication module 50A of the WEB server 50 receives these pieces of information.

Next, the communication module 50A transmits information such as the parking lot network data, the vacancy information, and the parking lot congestion information to the operation terminal 20 (Step S15). Specifically, the communication module 50A transmits these pieces of information to the operation terminal 20 of the user identified by the user ID of the vehicle state information of the target vehicle 100. The communication module 20A of the operation terminal 20 receives these pieces of information.

Next, the reception module 20G receives an instruction in selecting a parking section from the user. For example, the screen generation module 20C generates an in-parking-lot map on the basis of the parking lot network data and the vacancy information. The screen control module 20D outputs the image generated by the screen generation module 20C (see, for example, FIG. 3) to the display device of the operation terminal 20. The user selects a specific parking section from among the plurality of parking sections represented as the in-parking-lot map. The reception module 20G receives this selection as an instruction in selecting a parking section.

The communication module 20A transmits information such as the parking lot network data, the vacancy information, the parking lot congestion information, and the instruction in selecting a parking section to the navigation device 30 (Step S16). The navigation device 30 receives these pieces of information.

The parking section selection module 30F of the navigation device 30 selects a specific parking section that is a destination on the basis of the parking lot network data, the vacancy information, the parking lot congestion information, and the instruction in selecting a parking section (Step S17).

Next, the route generation module 30E generates a route in the parking lot 200 (Step S18). Specifically, the route generation module 30E generates a route from the entrance of the parking lot 200 to the selected parking section based on the parking lot network data and the self-position estimated by the self-position estimation module 30C.

Next, the navigation device 30 executes navigation (Step S19). Specifically, the map matching module 30D specifies the own vehicle position by map matching on the basis of the parking lot network data. The guidance information generation module 30G generates guidance information indicating a route to the selected parking section on the basis of the parking lot network data and the own vehicle position. The control module 30L displays the generated guidance information (see, for example, FIG. 3) on the display device of the navigation device 30.

Next, the vehicle 100 moves in the parking lot 200 according to the navigation (Step S20). Next, the infrastructure camera 80 captures a vehicle image of the target vehicle 100 (Step S21). Note that the vehicle image includes an image obtained by capturing the vehicle number.

The infrastructure camera 80 transmits the vehicle image to the infrastructure system 40 (Step S22). Note that a camera ID for identifying the infrastructure camera 80 is attached to the vehicle image. A communication module 70A of the recognition server 70 of the infrastructure system 40 receives the vehicle image to which the camera ID is attached.

Next, the analysis module 70B analyzes the vehicle image and acquires vehicle state information. At this time, the analysis module 70B acquires, for example, the vehicle position of the vehicle 100 after the start of moving and the camera ID obtained by capturing the vehicle image of the vehicle 100 after the start of movement. The communication module 70A transmits the vehicle state information acquired by the analysis module 70B to the navigation server 60. The communication module 60A of the navigation server 60 receives the vehicle state information.

Similarly to Step S14, the processing module 60E stores the received vehicle state information in the auxiliary storage device 11F, thereby updating the vehicle state information (Step S23). Specifically, the processing module 60E updates the vehicle position to the position where the infrastructure camera 80 that has captured the target vehicle 100 is installed, and the camera ID to the camera ID of the infrastructure camera 80 that has captured the target vehicle 100. As a result, the vehicle position and the vehicle state of the vehicle 100 are updated in real time.

Similarly to Step S15, the communication module 60A transmits information such as the parking lot network data, the vacancy information, and the parking lot congestion information to the operation terminal 20 (Step S24). The communication module 20A of the operation terminal 20 receives these pieces of information.

Next, the communication module 20A transmits information such as the parking lot network data, the vacancy information, and the parking lot congestion information to the navigation device 30 (Step S25). The navigation device 30 receives these pieces of information.

The route generation module 30E of the navigation device 30 generates a route in the parking lot 200 (Step S26). Next, the navigation device 30 executes navigation (Step S27).

If there is no change from the route generated in Step S18, the process of Step S26 is omitted, and navigation is executed according to the route generated in Step S18. Furthermore, the processes of Steps S20 to S27 is repeated until parking of the target vehicle 100 is detected. As a result, the navigation device 30 can correct the route in real time according to the situation in the parking lot 200.

Thereafter, the vehicle 100 parks in the target parking section (Step S28). Next, the infrastructure camera 80 captures a vehicle image of the target vehicle 100 (Step S29). The infrastructure camera 80 transmits the vehicle image to the infrastructure system 40 (Step S30). A communication module 70A of the recognition server 70 of the infrastructure system 40 receives the vehicle image to which the camera ID is attached.

At this time, the analysis module 70B detects parking of the target vehicle 100 by analyzing the vehicle image. Therefore, the determination module 70C determines that target vehicle 100 is a parked vehicle. The analysis module 70B acquires vehicle state information on the basis of the analysis result of the vehicle image, the determination result of the determination module 70C, and the like. The communication module 70A transmits the vehicle state information acquired by the analysis module 70B to the navigation server 60. The communication module 60A of the navigation server 60 receives the vehicle state information.

Similarly to Step S14, the processing module 60E stores the received vehicle state information in the auxiliary storage device 11F, thereby updating the vehicle state information (Step S31). Specifically, the processing module 60E updates the vehicle state to the parked vehicle, the vehicle position to the position of the parking section where the target vehicle 100 is parked, the camera ID to the camera ID of the camera that has captured the target vehicle 100, and the parking start time to the time when the analysis module 70B has detected parking.

Next, the processing module 60E updates the vacancy information (Step S32). Specifically, the processing module 60E updates the parking section where the target vehicle 100 is parked to the parking section in the parked state, and ends the process.

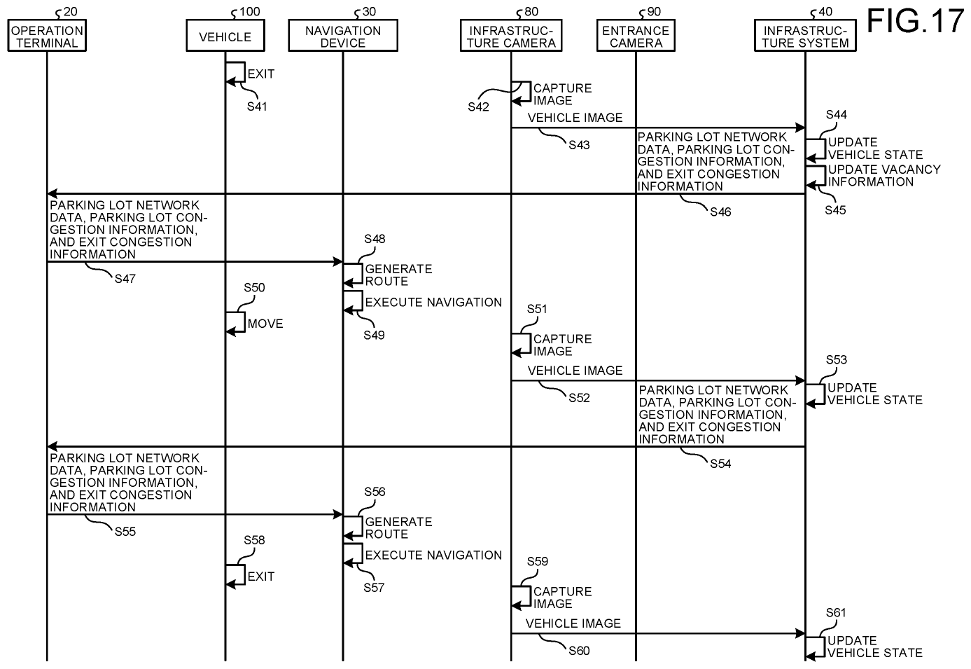

Next, the outbound navigation process for guiding the outbound vehicle from the parking position to a specific exit will be described. FIG. 17 is a sequence diagram illustrating an example of a procedure of information processing executed in the information processing system 10 according to the embodiment.

First, the vehicle 100 exits the parking section (Step S41). Next, the infrastructure camera 80 captures a vehicle image of the target vehicle 100 (Step S42). The infrastructure camera 80 transmits the vehicle image to the infrastructure system 40 (Step S43). A communication module 70A of the recognition server 70 of the infrastructure system 40 receives the vehicle image to which the camera ID is attached.

At this time, the analysis module 70B detects an exit of the target vehicle 100 by analyzing the vehicle image. Therefore, the determination module 70C determines that target vehicle 100 is an outbound vehicle. The analysis module 70B acquires vehicle state information on the basis of the analysis result of the vehicle image, the determination result of the determination module 70C, and the like. The communication module 70A transmits the vehicle state information acquired by the analysis module 70B to the navigation server 60. The communication module 60A of the navigation server 60 receives the vehicle state information.

The processing module 60E stores the received vehicle state information in the auxiliary storage device 11F, thereby updating the vehicle state information (Step S44). Specifically, the processing module 60E updates the vehicle state to the outbound vehicle, and updates the parking end time to the time when the analysis module 70B detects the exit. Next, the processing module 60E updates the vacancy information (Step S45). Specifically, the processing module 60E updates the parking section where the target vehicle 100 parked to the parking section in a vacant state.

The communication module 60A transmits information such as the parking lot network data, the parking lot congestion information, and the exit congestion information to the WEB server 50. The communication module 50A of the WEB server 50 receives these pieces of information. Next, the communication module 50A transmits information such as the parking lot network data, the parking lot congestion information, and the exit congestion information (Step S46). The communication module 20A of the operation terminal 20 receives these pieces of information.

Next, the reception module 20G receives an instruction in selecting an exit port from the user. For example, the screen generation module 20C generates an in-parking-lot map on the basis of the parking lot network data. The screen control module 20D outputs the image generated by the screen generation module 20C to the display device of the operation terminal 20. The user selects a specific exit from among the plurality of exits represented as the in-parking-lot map. The reception module 20G receives this selection as an instruction in selecting an exit port.

Next, the communication module 20A transmits information such as the parking lot network data, the parking lot congestion information, the exit congestion information, and the exit port to the navigation device 30 (Step S47). The navigation device 30 receives these pieces of information.

Next, the route generation module 30E generates a route in the parking lot 200 (Step S48). Specifically, the route generation module 30E generates a route from the parking section where the target vehicle 100 was parked to the selected exit based on the parking lot network data and the self-position estimated by the self-position estimation module 30C.

Next, the navigation device 30 executes navigation (Step S49). Next, the vehicle 100 moves in the parking lot 200 according to the navigation (Step S50). Next, the infrastructure camera 80 captures a vehicle image of the target vehicle 100 (Step S51).

The infrastructure camera 80 transmits the vehicle image to the infrastructure system 40 (Step S52). A communication module 70A of the recognition server 70 of the infrastructure system 40 receives the vehicle image to which the camera ID is attached.

Next, the analysis module 70B analyzes the vehicle image and acquires vehicle state information. At this time, the analysis module 70B acquires, for example, the vehicle position of the vehicle 100 after the start of moving and the camera ID obtained by capturing the vehicle image of the vehicle 100 after the start of movement. The communication module 70A transmits the vehicle state information acquired by the analysis module 70B to the navigation server 60. The communication module 60A of the navigation server 60 receives the vehicle state information.

Similarly to Step S44, the processing module 60E stores the received vehicle state information in the auxiliary storage device 11F, thereby updating the vehicle state information (Step S53). Specifically, the processing module 60E updates the vehicle position to the position where the infrastructure camera 80 that has captured the target vehicle 100 is installed, and the camera ID to the camera ID of the infrastructure camera 80 that has captured the target vehicle 100.

Similarly to Step S46, the communication module 50A of the WEB server 50 transmits information such as the parking lot network data and the parking lot congestion information to the operation terminal 20 (Step S54). The communication module 20A of the operation terminal 20 receives these pieces of information.

Next, the communication module 20A transmits information such as the parking lot network data, the vacancy information, the parking lot congestion information, and the instruction in selecting a parking section to the navigation device 30 (Step S55). The navigation device 30 receives these pieces of information.

The route generation module 30E of the navigation device 30 generates a route in the parking lot 200 (Step S56). Next, the navigation device 30 executes navigation (Step S57).

If there is no change from the route generated in Step S48, the process of Step S56 is omitted, and navigation is executed according to the route generated in Step S48. Furthermore, the processes of Steps S50 to S57 is repeated until the exit of the target vehicle 100 is detected.

Thereafter, the vehicle 100 exits the parking lot 200 (Step S58). Next, the infrastructure camera 80 captures a vehicle image of the target vehicle 100 (Step S59). The infrastructure camera 80 transmits the vehicle image to the infrastructure system 40 (Step S60). A communication module 70A of the recognition server 70 of the infrastructure system 40 receives the vehicle image to which the camera ID is attached.

At this time, the analysis module 70B detects the exit of the target vehicle 100 by analyzing the vehicle image. Therefore, the determination module 70C determines that target vehicle 100 is an undefined vehicle. The analysis module 70B acquires vehicle state information on the basis of the analysis result of the vehicle image, the determination result of the determination module 70C, and the like. The communication module 70A transmits the vehicle state information acquired by the analysis module 70B to the navigation server 60. The communication module 60A of the navigation server 60 receives the vehicle state information.

The processing module 60E stores the received vehicle state information in the auxiliary storage device 11F, thereby updating the vehicle state information (Step S61). Specifically, the processing module 60E updates the vehicle state to an undefined state, the vehicle position to the position of the exit from which the target vehicle 100 has exited, and the camera ID to the camera ID of the camera that has captured the target vehicle 100, and ends the process.

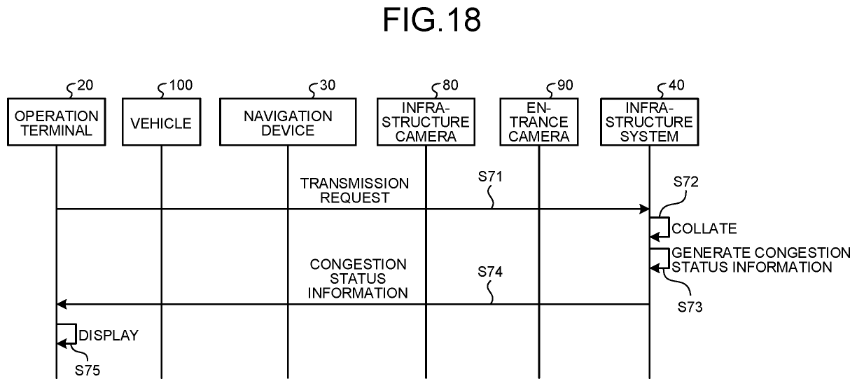

Next, a congestion status confirmation process for confirming the congestion status of the vehicle 100 in the vicinity of the exit will be described. FIG. 18 is a sequence diagram illustrating an example of a procedure of information processing executed in the information processing system 10 according to the embodiment. As a premise, it is assumed that the user inputs the user information and the vehicle number information in the input form 8a of the congestion status confirmation request screen 8 displayed on the display device of the operation terminal 20, and presses the congestion status confirmation button 8b.

First, the communication module 20A of the operation terminal 20 transmits a congestion status confirmation request to the infrastructure system 40 (Step S71). The congestion status confirmation request includes the user information and the vehicle number information. The communication module 50A of the WEB server 50 of the infrastructure system 40 receives the congestion status confirmation request.

The communication module 50A transmits the congestion status confirmation request received from the operation terminal 20 to the navigation server 60. The communication module 60A of the navigation server 60 receives the congestion status confirmation request.

Next, the collation module 60D collates the user information and the vehicle number information (Step S72). Specifically, the collation module 60D collates the user information and the vehicle number information included in the congestion status confirmation request with the user information and the vehicle number information included in the user registration information.

In a case where the collation results match, the processing module 60E generates exit congestion information corresponding to the user information and the vehicle number information included in the congestion status confirmation request as congestion status information (Step S73).

Specifically, the processing module 60E specifies a parking area where the vehicle 100 of the target user is parked from the vehicle state information. Next, the processing module 60E specifies an exit available to the vehicle 100 of the user who has transmitted the congestion status confirmation request from the specified parking area and parking lot network data.

Then, the processing module 60E generates congestion status information based on the specified available exit and exit congestion information. Note that, if the collation results do not match, this process is ended.

The communication module 60A transmits the generated congestion status information to the WEB server 50. The communication module 50A of the WEB server 50 receives the congestion status information. Next, the communication module 50A transmits the congestion status information to the operation terminal 20 (Step S74).

The communication module 20A of the operation terminal 20 receives the congestion status information. The screen generation module 20C generates a congestion status confirmation screen on the basis of the congestion status information. Next, the screen control module 20D displays a congestion status confirmation screen (see, for example, FIG. 9) on the display device of the operation terminal 20, and ends this process (Step S75).

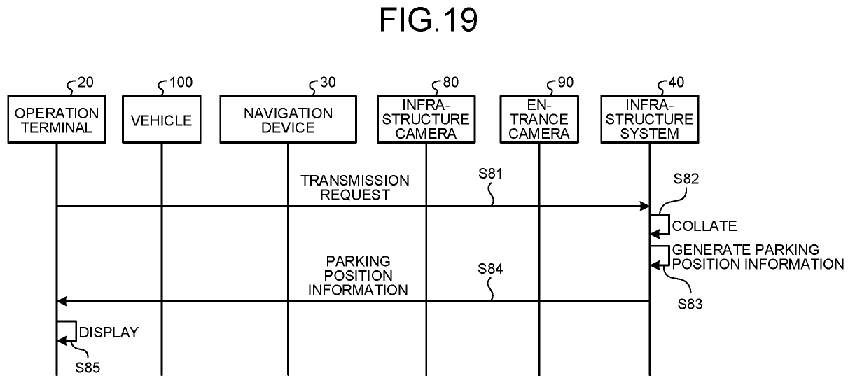

Next, a parking area confirmation process for confirming the parking position of the vehicle 100 of the user will be described. FIG. 19 is a sequence diagram illustrating an example of a procedure of information processing executed in the information processing system 10 according to the embodiment. As a premise, it is assumed that the user inputs the user information and the vehicle number information in the input form 12a of the parking area confirmation request screen 12 displayed on the display device of the operation terminal 20, and presses the parking area confirmation button 12b.

Since the processes in Steps S81 and S82 are similar to the processes in Steps S71 and S72 in FIG. 18, detailed description thereof is omitted. In a case where the collation results by the collation module 60D match, the processing module 60E generates parking position information corresponding to the user information and the vehicle number information included in the parking area confirmation request (Step S83).

Specifically, the processing module 60E specifies a parking section where the vehicle 100 of the target user is parked from the vehicle state information and the parking lot network data. Next, the processing module 60E acquires information of the vehicle 100 around the specified parking section from the vehicle state information and the parking lot network data.

Then, the processing module 60E generates parking position information on based on the information on the specified parking section and the information on the vehicle 100 around the specified parking section. Note that, if the collation results do not match, this process is ended.

The communication module 60A transmits the generated parking position information to the WEB server 50. The communication module 50A of the WEB server 50 receives the parking position information. Next, the communication module 50A transmits the parking position information to the operation terminal 20 (Step S84).

The communication module 20A of the operation terminal 20 receives the information. The screen generation module 20C generates a parking area confirmation screen on the basis of the parking position information. Next, the screen control module 20D displays a parking area confirmation screen (see, for example, FIG. 11) on the display device of the operation terminal 20, and ends this process (Step S85).

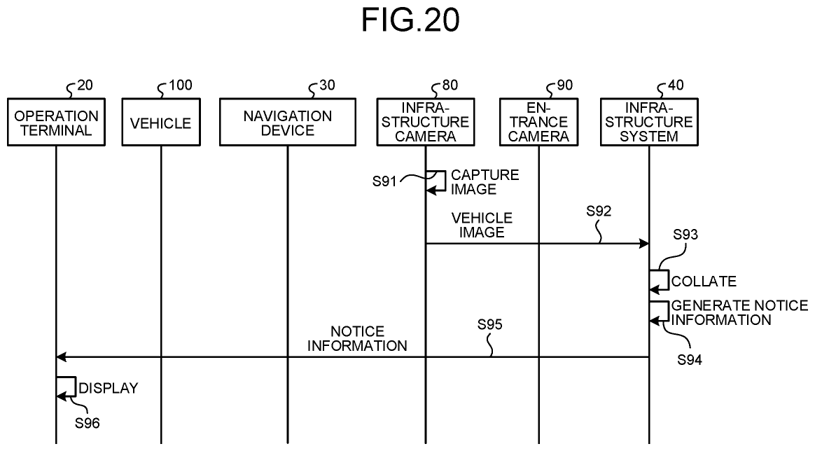

Next, a notice information notification process for notifying the user of information will be described. FIG. 20 is a sequence diagram illustrating an example of a procedure of information processing executed in the information processing system 10 according to the embodiment. As a premise, it is assumed that the user has parked the vehicle 100 in a specific parking section.

First, the infrastructure camera 80 captures a vehicle image of the target vehicle 100 (Step S91). The infrastructure camera 80 transmits the vehicle image to the infrastructure system 40 (Step S92). The analysis module 70B of the recognition server 70 executes analysis of the vehicle image. The analysis module 70B determines the analysis result, and in a case where the analysis result does not satisfy the predetermined condition, ends this process.

In a case where the analysis result satisfies the predetermined condition, the collation module 60D collates the user information and the vehicle number information (Step S93). Specifically, the collation module 60D collates the vehicle number information included in the vehicle image with the vehicle number information included in the user registration information. As a result, it is possible to confirm that the user of the vehicle 100 imaged by the infrastructure camera 80 is the user of the parking lot navigation system.

If the collation results match, the processing module 60E generates notice information corresponding to a predetermined condition (Step S94). For example, in a case where the analysis module 70B of the recognition server 70 detects that the parking time of the vehicle 100 exceeds a predetermined time on the basis of the analysis result of the vehicle image and the vehicle state information, the processing module 60E generates notice information for notifying the user of the fact. Note that, if the collation results do not match, this process is ended.

The communication module 60A transmits the generated notice information to the WEB server 50. The communication module 50A of the WEB server 50 receives the notice information. Next, the communication module 50A transmits the notice information to the operation terminal 20 (Step S95).

The communication module 20A of the operation terminal 20 receives the notice information. The screen generation module 20C generates a notice information display screen on the basis of the notice information. Next, the screen control module 20D displays the notice information display screen (see, for example, FIG. 12) on the display device of the operation terminal 20, and ends this process (Step S96).

When receiving the notice information, the operation terminal 20 may notify the user of only the reception of the notice information. In this case, when the user presses the notice display button 5e on the menu screen 5, the screen generation module 20C generates a notice information display screen on the basis of the provided notice information. Thereafter, the screen control module 20D displays the notice information display screen on the display device of the operation terminal 20.

### Processing of Infrastructure System

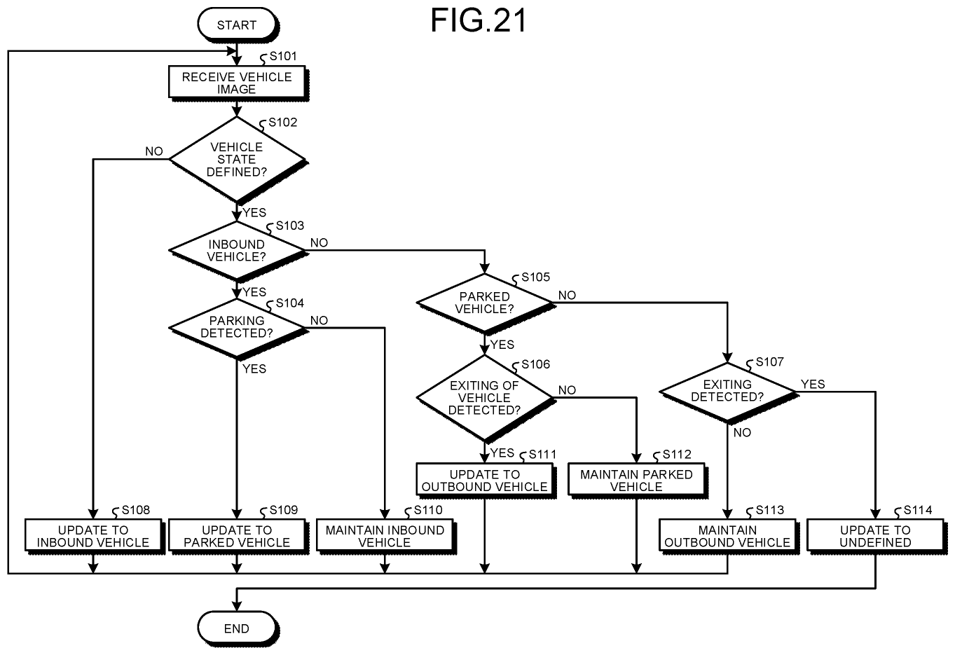

Next, vehicle state determination processing executed by the infrastructure system 40 according to the embodiment will be described. FIG. 21 is a flowchart illustrating an example of information processing executed by the infrastructure system 40 according to the embodiment.

First, the communication module 70A of the recognition server 70 receives the vehicle image from the infrastructure camera 80 or the entrance camera 90 (Step S101). Next, the analysis module 70B detects the vehicle number, the vehicle position, and the like of each of the vehicles 100 included in the vehicle image by analyzing the received vehicle image. Hereinafter, each of the vehicles 100 detected from the vehicle image is also referred to as a target vehicle 100.

In addition, the determination module 70C confirms whether or not the vehicle state of the target vehicle 100 is defined on the basis of the analysis result of the vehicle image of the analysis module 70B or the like (Step S102). Specifically, the determination module 70C refers to the vehicle state information stored in the auxiliary storage device 11F of the navigation server 60, and confirms the vehicle state associated with the vehicle number included in the vehicle image.

If the vehicle state is not defined (Step S102: No), the determination module 70C determines that the vehicle state of the corresponding vehicle 100 is an inbound vehicle. The determination result is transmitted to the navigation server 60 as vehicle state information together with the vehicle number and the like by the communication module 70A. The communication module 60A of the navigation server 60 receives the vehicle state information.

Then, the processing module 60E stores the received vehicle state information in the auxiliary storage device 11F, thereby updating the vehicle state information (Step S108). Specifically, the processing module 60E updates the vehicle state of the target vehicle 100 from undefined to an inbound vehicle, and returns to the process of Step S101.

On the other hand, if the vehicle state is defined in Step S102 (Step S102: Yes), the determination module 70C confirms whether or not the vehicle state is an inbound vehicle (Step S103). If the vehicle is an inbound vehicle (Step S103: Yes), the determination module 70C confirms whether or not parking of the target vehicle 100 has been detected by analyzing the vehicle image by the analysis module 70B (Step S104).

If the parking is not detected (Step S104: No), the determination module 70C determines that the vehicle state of the target vehicle 100 is an inbound vehicle. In this case, the processing module 60E maintains the vehicle state as the inbound vehicle (Step S110). Thereafter, the process returns to Step S101.

On the other hand, if the parking is detected (Step S104: Yes), the determination module 70C determines that the vehicle state of the target vehicle 100 is a parked vehicle. Thereafter, the processing module 60E updates the vehicle state of the target vehicle 100 from the inbound vehicle to the parked vehicle. (Step S109). Thereafter, the process returns to Step S101.

If the vehicle is not an inbound vehicle in Step S103 (Step S103: No), the determination module 70C confirms whether or not the vehicle state is a parked vehicle (Step S105). If the vehicle is a parked vehicle (Step S105: Yes), the determination module 70C confirms whether or not exiting of the target vehicle 100 has been detected by analyzing the vehicle image by the analysis module 70B (Step S106).

If the exiting is not detected (Step S106: No), the determination module 70C determines that the vehicle state of the target vehicle 100 is a parked vehicle. In this case, the processing module 60E maintains the vehicle state as the parked vehicle (Step S112). Thereafter, the process returns to Step S101.

On the other hand, if the exiting is detected (Step S106: Yes), the determination module 70C determines that the vehicle state of the target vehicle 100 is an outbound vehicle. Thereafter, the processing module 60E updates the vehicle state of the target vehicle 100 from the parked vehicle to the outbound vehicle (Step S111). Thereafter, the process returns to Step S101.

If the vehicle is not a parked vehicle (Step S105: No) in Step 105, the determination module 70C determines that the vehicle state of the target vehicle 100 is an outbound vehicle. Then, the determination module 70C confirms whether or not exiting of the target vehicle 100 has been detected by analyzing the vehicle image by the analysis module 70B (Step S107). If the exiting is not detected (Step S107: No), the processing module 60E maintains the vehicle state as the outbound vehicle (Step S113). Thereafter, the process returns to Step S101.

On the other hand, if the exiting is detected (Step S107: Yes), the determination module 70C determines that the vehicle state of the target vehicle 100 is an undefined vehicle. Thereafter, the processing module 60E updates the vehicle state of the target vehicle 100 from the outbound vehicle to the undefined vehicle, and ends the process (Step S114).

### Effects of Information Processing System

Next, effects of the information processing system 10 will be described. According to the information processing system 10 according to the present embodiment, by capturing an image of the vehicle 100 present in the parking lot 200 by the infrastructure camera 80 or the entrance camera 90, it is possible to determine whether the captured vehicle 100 is an inbound vehicle, a parked vehicle, or an outbound vehicle. Furthermore, the information processing system 10 can also grasp, from the installation position of the infrastructure camera 80, which position in the parking lot 200 the inbound vehicle and the outbound vehicle are traveling.

As a result, in a case where the vehicle 100 is guided to a specific parking section, it is possible to provide a route that can avoid congestion in consideration of the positions and the number of inbound vehicles and outbound vehicles. Similarly, in a case where the parked vehicle 100 is guided to the exit, it is also possible to provide a route that can avoid congestion in consideration of the positions and the number of inbound vehicles and outbound vehicles. In addition, in a case where the parked vehicle 100 is guided to the exit, it is also possible to select an exit where there are few vehicles 100 staying in the periphery.

That is, according to the information processing system 10 of the present embodiment, it is possible to determine a congestion factor with respect to congestion in a parking lot and to provide route guidance depending on the purpose of entering or exiting.

Note that the above-described embodiment can be appropriately modified and implemented by changing a part of the configuration or function of each device of the information processing system 10. Therefore, in the following, some modifications according to the above-described embodiment will be described as other embodiments. In the following description, points different from the above-described embodiment will be mainly described, and detailed description of points common to the contents already described will be omitted. In addition, the modifications described below may be implemented individually, or may be implemented in appropriate combination.

### First Modification Example

In the above-described embodiment, a mode in which the information processing system 10 includes the navigation device 30 has been described. However, the information processing system 10 does not necessarily include the navigation device 30. Hereinafter, a configuration without having the navigation device 30 will be described.

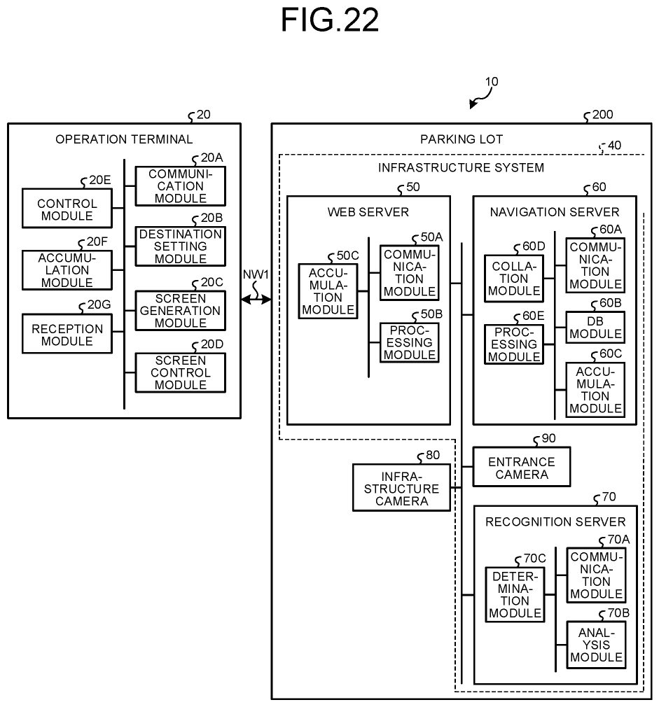

FIG. 22 is a block diagram illustrating an example of a configuration of the information processing system 10 according to the first modification example. As illustrated in FIG. 22, the information processing system 10 includes an operation terminal 20 and an infrastructure system 40.

In the present modification, the screen generation module 20C of the operation terminal 20 generates an in-parking-lot map screen on the basis of the parking lot network data, the vacancy information, the parking lot congestion information, and the like transmitted from the infrastructure system 40.

The in-parking-lot map screen is, for example, a screen such as the inbound navigation screen 3 illustrated in FIG. 3. However, since the navigation device 30 is not provided, there is no route display 3c. The screen control module 20D displays the in-parking-lot map screen generated by the screen generation module 20C to the display device of the operation terminal 20.

At this time, the user checks the in-parking-lot map screen including the vacancy information, and determines a target parking section from among the vacant parking sections. Note that information indicating the position of the parking section determined by the user may be displayed on the in-parking-lot map screen. In this case, the reception module 20G receives an instruction in determination of a target parking section from the user. Then, the screen generation module 20C generates the in-parking-lot map screen including the information on the position of the target parking section determined by the user.

When the vehicle 100 travels in the parking lot 200, a vehicle image is captured by the infrastructure camera 80. As a result, the vehicle state information is updated in real time. The operation terminal 20 can grasp the position of the own vehicle in the parking lot 200 by receiving the vehicle state information in real time. Note that the position of the own vehicle is superimposed and displayed on the in-parking-lot map screen.

The user causes the vehicle 100 to travel to the target parking section while confirming the in-parking-lot map screen and the position of the own vehicle that are updated in real time. Note that, since the congestion information in the parking lot is also reflected in the in-parking-lot map, the user can cause the vehicle 100 to travel to the target parking section while avoiding congestion.

The infrastructure system 40 performs substantially the same processes as the above-described embodiment, but the communication module 60A of the navigation server 60 transmits the vehicle state information of the target vehicle 100 when transmitting the parking lot network data, the vacancy information, the parking lot congestion information, and the like to the operation terminal 20. This is to enable the operation terminal 20 side to grasp the position of the own vehicle as described above.

Note that the infrastructure system 40 may execute a process such as route generation and navigation process. As a result, route guidance can also be displayed for the vehicle 100 that does not include the navigation device 30.

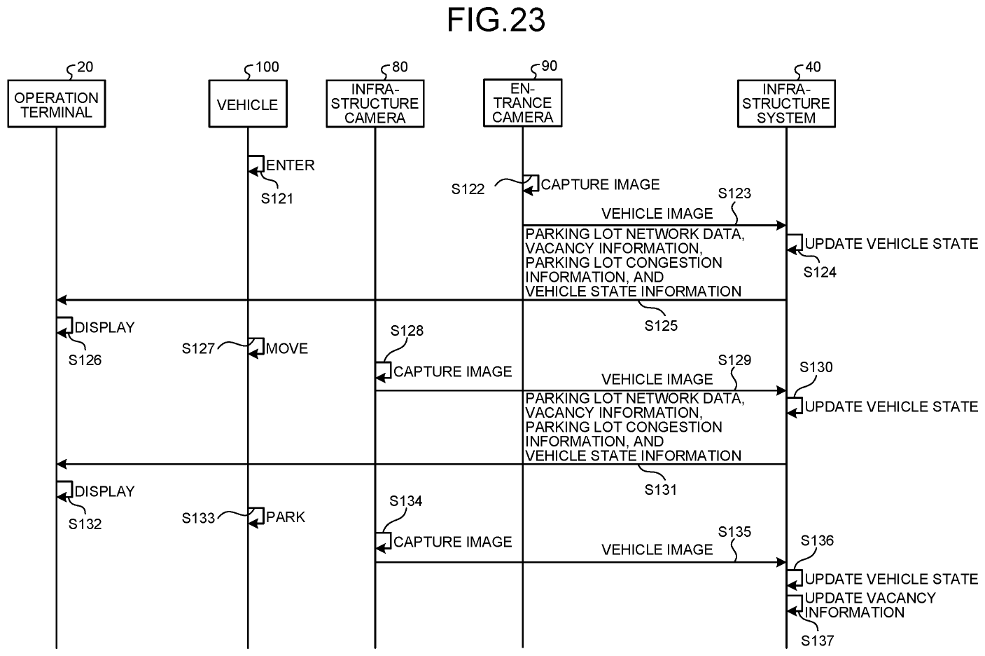

Next, a procedure of information processing executed by the information processing system 10 according to the first modification example will be described. First, the inbound navigation process according to the first modification example will be described. FIG. 23 is a sequence diagram illustrating an example of a procedure of information processing executed in the information processing system 10 according to the first modification example.

Since the processes in Steps S121 to S124 are similar to the processes in Steps S11 to S14 in FIG. 16, detailed description thereof is omitted. After updating the vehicle state information in Step S124, the communication module 60A transmits information such as the parking lot network data, the vacancy information, the parking lot congestion information, and the vehicle state information to the WEB server 50. The communication module 50A of the WEB server 50 receives these pieces of information.

Next, the communication module 50A transmits information such as the parking lot network data, the vacancy information, the parking lot congestion information, and the vehicle state information to the operation terminal 20 (Step S125). The communication module 20A of the operation terminal 20 receives these pieces of information.

The screen generation module 20C generates an in-parking-lot map screen on the basis of the parking lot network data, the vacancy information, the parking lot congestion information, and the like received from the infrastructure system 40. Next, the screen control module 20D displays the generated in-parking-lot map screen (Step S126).

At this time, the user checks the in-parking-lot map screen including the vacancy information, and determines a target parking section. Note that information on the position of the own vehicle is superimposed and displayed on the in-parking-lot map screen. Then, the vehicle 100 starts moving toward the target parking section (Step S127).

After the vehicle 100 starts moving toward the target parking section, the process proceeds to Step S128, but the processes of Steps S128 to S130 are similar to the processes of Steps S21 to S23 in FIG. 16, and thus detailed description is omitted.

After updating the vehicle state information in Step S130, the communication module 50A of the WEB server 50 transmits information similar to that in Step S125 to the operation terminal 20 (Step S131). The communication module 20A of the operation terminal 20 receives these pieces of information.

The screen generation module 20C and the screen control module 20D perform, similarly to Step S126, processes of generating and displaying the in-parking-lot map screen (Step S132).

Moreover, the processes of Steps S127 to S132 are repeated until parking of the target vehicle 100 is detected. As a result, the in-parking-lot map and the information on the position of the own vehicle are updated in real time. Therefore, the user can cause the own vehicle to travel to a target vacant parking section based on the in-parking-lot map and the information on the position of the own vehicle updated in real time.

When reaching the target parking section, the vehicle 100 parks in the parking section (Step S133). Then, the process proceeds to Step S134, but the processes of Steps S134 to S137 are similar to the processes of Steps S29 to S32 in FIG. 16, and thus detailed description is omitted.

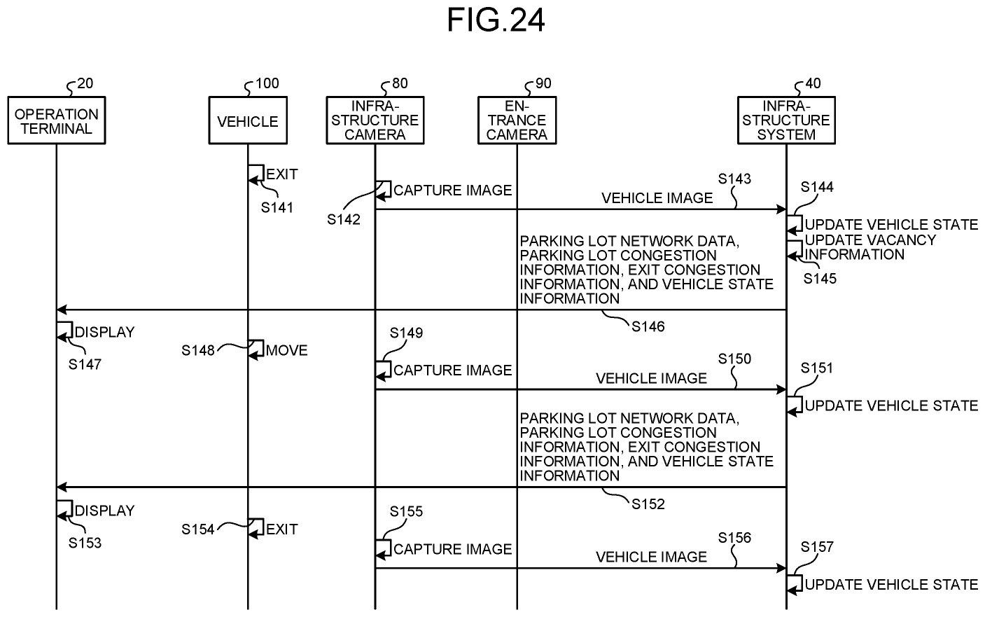

Next, the outbound navigation process according to the first modification example will be described. FIG. 24 is a sequence diagram illustrating an example of a procedure of information processing executed in the information processing system 10 according to the first modification example.

Since the processes in Steps S141 to S145 are similar to the processes in Steps S41 to S45 in FIG. 17, detailed description thereof is omitted. After updating the vehicle state information in Step S145, the communication module 60A transmits information such as the parking lot network data, the parking lot congestion information, the exit congestion information, and the vehicle state information to the WEB server 50. The communication module 50A of the WEB server 50 receives these pieces of information.

Next, the communication module 50A transmits information such as the parking lot network data, the parking lot congestion information, the exit congestion information, and the vehicle state information to the operation terminal 20 (Step S146). The communication module 20A of the operation terminal 20 receives these pieces of information.

Next, the screen generation module 20C and the screen control module 20D perform, similarly to Step S126 in FIG. 23, processes of generating and displaying the in-parking-lot map screen (Step S147). At this time, the user checks the in-parking-lot map screen including the exit congestion information, and determines a target exit. Then, the vehicle 100 starts moving toward the exit (Step S148).

After the vehicle 100 starts moving toward the target exit, the process proceeds to Step S149, but the processes of Steps S149 to S151 are similar to the processes of Steps S51 to S53 in FIG. 17, and thus detailed description is omitted.

After updating the vehicle state information in Step S151, the communication module 50A of the WEB server 50 transmits information similar to that in Step S146 to the operation terminal 20 (Step S152). The communication module 20A of the operation terminal 20 receives these pieces of information.

The screen generation module 20C and the screen control module 20D perform, similarly to Step S147, processes of generating and displaying the in-parking-lot map screen (Step S153).

Moreover, the processes of Steps S148 to S153 are repeated until the exit of the target vehicle 100 is detected. As a result, the in-parking-lot map and the information on the position of the own vehicle are updated in real time. Therefore, the user can cause the own vehicle to travel to a target exit based on the in-parking-lot map and the information on the position of the own vehicle updated in real time.

The vehicle 100 exits from the target exit (Step S154). Then, the process proceeds to Step S155, but the processes of Steps S155 to S157 are similar to the processes of Steps S59 to S61 in FIG. 17, and thus detailed description is omitted.

According to the present modification, it is possible to provide information on the current position of the own vehicle and congestion information in the parking lot 200 even to the vehicle 100 without having the navigation device 30 while traveling in the parking lot 200. In addition, since the user can grasp whether the vehicle 100 in the parking lot 200 is an inbound vehicle, a parked vehicle, or an outbound vehicle, it is possible to cause the vehicle 100 to enter or exit the parking lot while avoiding congestion.

### Second Modification Example

In the embodiment described above, a mode in which the infrastructure system 40 includes the infrastructure camera 80 has been described. However, the infrastructure system 40 does not necessarily need to include the infrastructure camera 80. Hereinafter, a configuration without having the infrastructure camera 80 will be described.

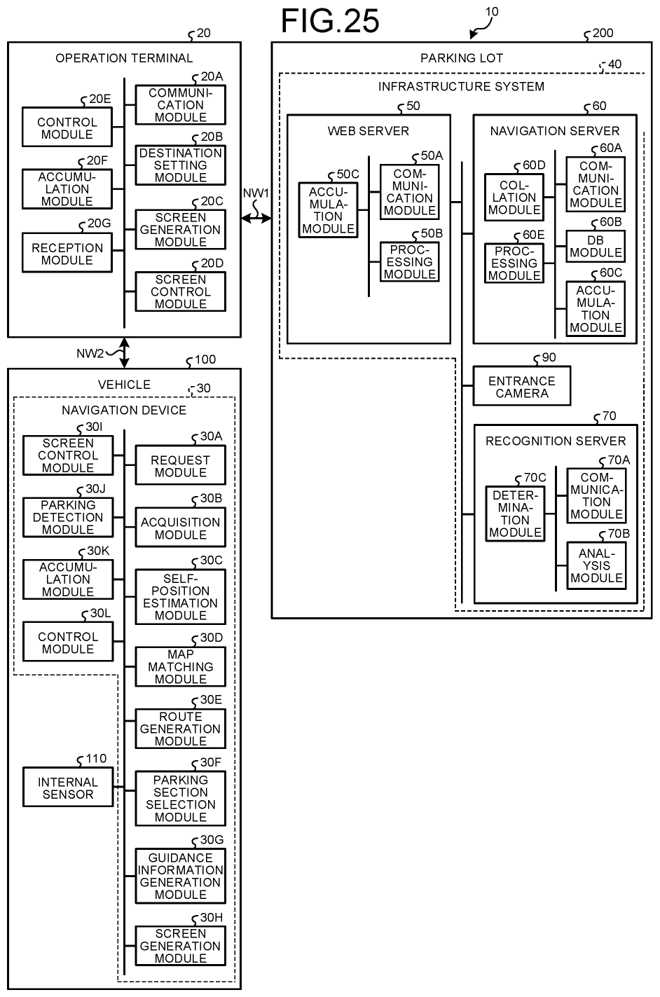

FIG. 25 is a block diagram illustrating an example of a configuration of the information processing system 10 according to the second modification example. The information processing system 10 is different from the above-described embodiment in that the infrastructure camera 80 is not provided.

The navigation device 30 of the present modification transmits the position of the own vehicle estimated by the self-position estimation module 30C to the operation terminal 20 in real time as vehicle position information indicating the position of the own vehicle. The communication module 20A of the operation terminal 20 receives the vehicle position information. The communication module 20A transmits the vehicle position information to the infrastructure system 40.

As a result, the infrastructure system 40 can grasp the vehicle position of the target vehicle 100 even if the infrastructure camera 80 is not provided. The infrastructure system 40 can also grasp the operation of the vehicle 100 related to the vehicle position information by continuously acquiring the vehicle position information. Therefore, it can be said that the vehicle position information is an example of the position/operation information.

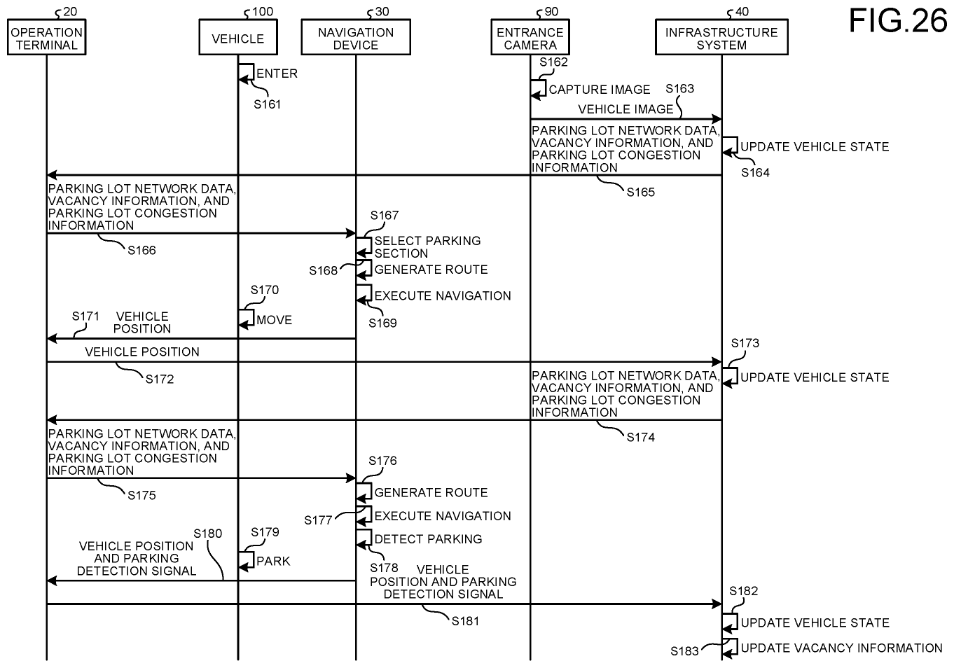

Next, a procedure of information processing executed by the information processing system 10 according to the second modification example will be described. First, the inbound navigation process according to the second modification example will be described. FIG. 26 is a sequence diagram illustrating an example of a procedure of information processing executed in the information processing system 10 according to the second modification example.

Since the processes in Steps S161 to S170 are similar to the processes in Steps S11 to S20 in FIG. 16, detailed description thereof is omitted. After the vehicle 100 starts moving toward the target parking section in Step S170, the navigation device 30 transmits vehicle position information to the operation terminal 20 (Step S171). Then, the communication module 20A of the operation terminal 20 receives the vehicle position information.

Next, the communication module 20A transmits the vehicle position information to the infrastructure system 40 (Step S172). After the vehicle position information is transmitted in Step S172, the process proceeds to Step S173, but the processes of Steps S173 to S177 are similar to the processes of Steps S23 to S27 in FIG. 16, and thus detailed description is omitted.

When the vehicle 100 is parked in Step S178, the parking detection module 30J of the navigation device 30 detects parking of the target vehicle 100 (Step S179). Specifically, in the parking lot network data, the parking detection module 30J detects parking in a case where the own vehicle position specified by the map matching module 30D is present in the parking section selected as the destination.

Thereafter, the navigation device 30 transmits vehicle position information and a parking detection signal indicating that parking has been detected to the operation terminal 20 (Step S180). Then, the communication module 20A of the operation terminal 20 receives the vehicle position information and the parking detection signal. Next, the communication module 20A transmits the vehicle position information and the parking detection signal to the infrastructure system 40 (Step S181).

After the vehicle position information and the parking detection signal are transmitted in Step S181, the process proceeds to Step S182, but the processes of Steps S182 to S183 are similar to the processes of Steps S31 to S32 in FIG. 16, and thus detailed description is omitted.

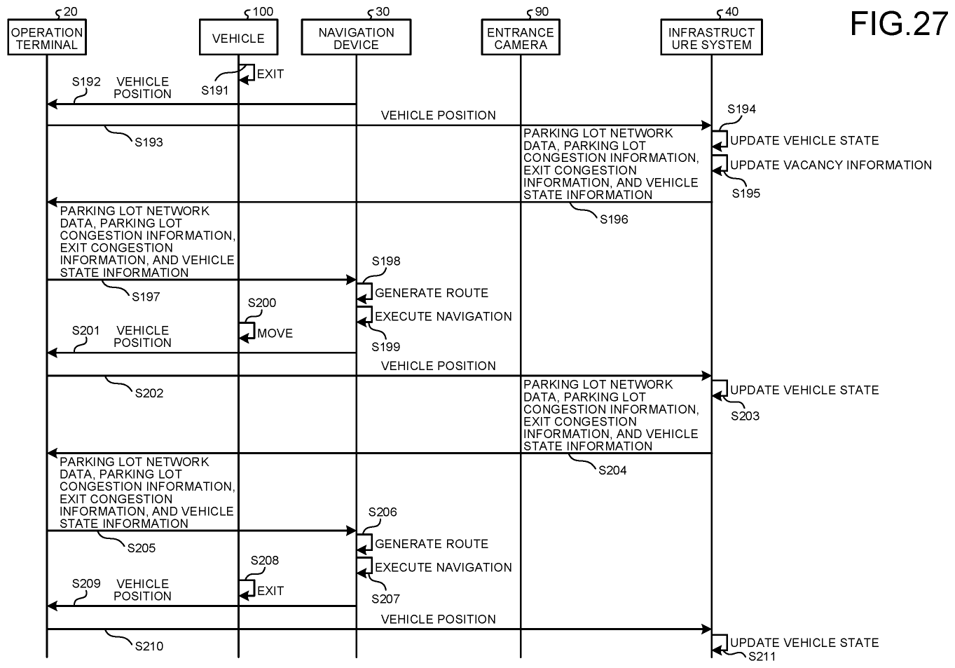

Next, the outbound navigation process according to the second modification example will be described. FIG. 27 is a sequence diagram illustrating an example of a procedure of information processing executed in the information processing system 10 according to the second modification example.

Since the processes in Step S191 is similar to the process in Step S41 in FIG. 17, detailed description thereof is omitted. After the vehicle 100 exits, the navigation device 30 transmits vehicle position information to the operation terminal 20 (Step S192). Then, the communication module 20A of the operation terminal 20 receives the vehicle position information.

Next, the communication module 20A transmits the vehicle position information to the infrastructure system 40 (Step S193). After the vehicle position information is transmitted in Step S193, the process proceeds to Step S194, but the processes of Steps S194 to S200 are similar to the processes of Steps S44 to S50 in FIG. 17, and thus detailed description is omitted.

After the vehicle 100 starts moving toward the target exit, the navigation device 30 transmits vehicle position information to the operation terminal 20 (Step S201). Then, the communication module 20A of the operation terminal 20 receives the vehicle position information.

Next, the communication module 20A transmits the vehicle position information to the infrastructure system 40 (Step S202). After the vehicle position information is transmitted in Step S202, the process proceeds to Step S203, but the processes of Steps S203 to S208 are similar to the processes of Steps S53 to S58 in FIG. 17, and thus detailed description is omitted.

After the target vehicle 100 exits in Step S208, the navigation device 30 transmits vehicle position information to the operation terminal 20 (Step S209). Then, the communication module 20A of the operation terminal 20 receives the vehicle position information.

Next, the communication module 20A transmits the vehicle position information to the infrastructure system 40 (Step S210). After the vehicle position information is transmitted in Step S210, the process proceeds to Step S211, but the process of Step S211 is similar to the process of Step S61 in FIG. 17, and thus detailed description is omitted.

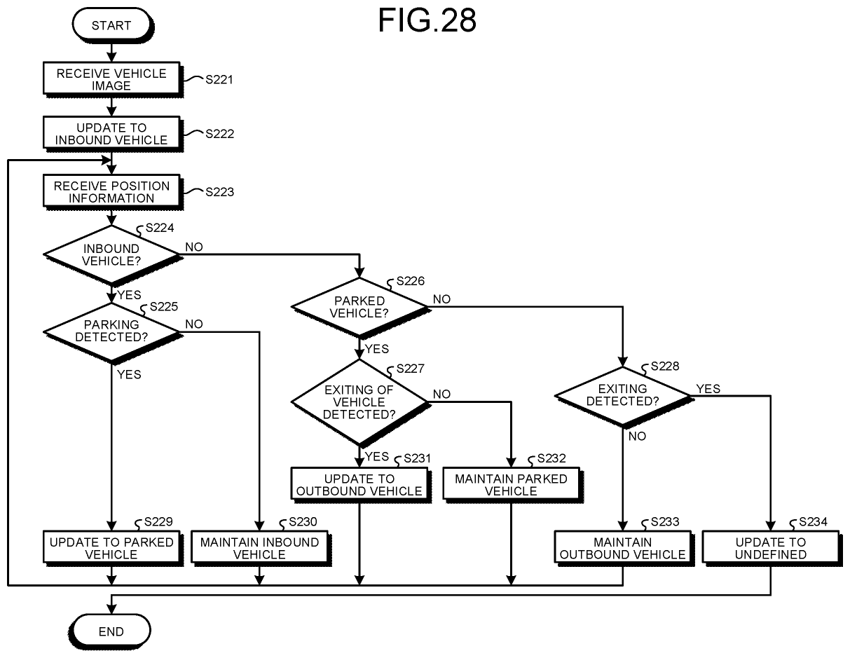

Next, vehicle state determination processing executed by the infrastructure system 40 according to the second modification example will be described. FIG. 28 is a flowchart illustrating an example of information processing executed by the infrastructure system 40 according to the second modification example.

First, the communication module 70A of the recognition server 70 receives a vehicle image of the vehicle 100 from the entrance camera 90 (Step S221). Next, the analysis module 70B detects the vehicle number, the vehicle type, color, and the like of each of the vehicles 100 included in the vehicle image by analyzing the received vehicle image of the vehicle 100.

Next, the determination module 70C determines that the vehicle state of the target vehicle 100 is an inbound vehicle because the analysis module 70B detects that the target vehicle 100 is included in the vehicle image captured by the entrance camera 90 by analyzing the vehicle image. The determination result is transmitted to the navigation server 60 as vehicle state information together with the vehicle number and the like by the communication module 70A. The communication module 60A of the navigation server 60 receives the vehicle state information.

Then, the processing module 60E stores the received vehicle state information in the auxiliary storage device 11F, and updates the vehicle state of the target vehicle 100 from undefined to the inbound vehicle (Step S222). Thereafter, the communication module 70A of the recognition server 70 receives the vehicle position information from the operation terminal 20 (Step S223).

Next, the determination module 70C confirms whether or not the vehicle state of the target vehicle 100 is an inbound vehicle based on the vehicle position information (Step S224). If the vehicle is an inbound vehicle (Step S224: Yes), the determination module 70C confirms whether or not parking of the target vehicle 100 has been detected depending on whether or not a parking detection signal has been received from the navigation device 30 (Step S225).

If the parking is not detected (Step S225: No), the determination module 70C determines that the vehicle state of the target vehicle 100 is an inbound vehicle. In this case, the processing module 60E maintains the vehicle state as the inbound vehicle (Step S230). Thereafter, the process returns to Step S223.

On the other hand, if the parking is detected (Step S225: Yes), the determination module 70C determines that the vehicle state of the target vehicle 100 is a parked vehicle. Thereafter, the processing module 60E updates the vehicle state of the target vehicle 100 from the inbound vehicle to the parked vehicle (Step S229). Thereafter, the process returns to Step S223.

If the vehicle is not an inbound vehicle in Step S224 (Step S224: No), the determination module 70C confirms whether or not the vehicle state or the target vehicle 100 is a parked vehicle based on the vehicle position information (Step S226). If the vehicle is a parked vehicle (Step S226: Yes), the determination module 70C confirms whether or not exiting of the target vehicle 100 has been detected based on the vehicle position information (Step S227).

If the exiting is not detected (Step S227: No), the determination module 70C determines that the vehicle state of the target vehicle 100 is a parked vehicle. In this case, the processing module 60E maintains the vehicle state as the parked vehicle (Step S232). Thereafter, the process returns to Step S223.

On the other hand, if the start of moving is detected (Step S227: Yes), the determination module 70C determines that the vehicle state of the target vehicle 100 is an outbound vehicle. Thereafter, the processing module 60E updates the vehicle state of the target vehicle 100 from the parked vehicle to the outbound vehicle (Step S231). Thereafter, the process returns to Step S223.

If the vehicle is not a parked vehicle (Step S226: No) in Step S226, the determination module 70C determines that the vehicle state of the target vehicle 100 is an outbound vehicle. Next, the determination module 70C confirms whether or not exiting of the target vehicle 100 is detected based on the vehicle position information (Step S228). If the exiting is not detected (Step S228: No), the processing module 60E maintains the vehicle state as the outbound vehicle (Step S233). Thereafter, the process returns to Step S223.

On the other hand, if the exiting is detected (Step S228: Yes), the determination module 70C determines that the vehicle state of the target vehicle 100 is an undefined vehicle. Thereafter, the processing module 60E updates the vehicle state of the target vehicle 100 from the outbound vehicle to the undefined vehicle, and ends the process (Step S234).

According to the present modification, the vehicle position of the vehicle 100 including the navigation device 30 can be grasped without the infrastructure camera 80. According to the information processing system 10 of the present modification, it is possible to determine a congestion factor with respect to congestion in a parking lot while reducing cost, and to provide route guidance depending on the purpose of entering or exiting.

### Third Modification Example

In the above-described embodiment, a mode in which the infrastructure system 40 includes three server devices of the WEB server 50, the navigation server 60, and the recognition server 70 has been described. However, the number of server devices is not limited to three.

For example, the infrastructure system 40 may be configured by one server device having the functions of the WEB server 50, the navigation server 60, and the recognition server 70. Further, for example, the infrastructure system 40 may be configured by the WEB server 50 and a server device having the functions of the navigation server 60 and the recognition server 70.

According to the present modification, the functions of the infrastructure system 40 can be distributed to a plurality of devices or integrated into one device according to the situation.

Note that the program for executing the information processing in the above-described embodiment has a module configuration including each of the plurality of functional units, and as actual hardware, for example, when a CPU (processor circuit) reads the information processing program from a ROM or an HDD and executes the information processing program, each of the plurality of functional units described above is loaded onto a RAM (main memory), and each of the plurality of functional units described above is generated on the RAM (main memory).

As an example, the CPU 11A of the navigation device 30 loads various programs stored in the auxiliary storage device 11F into the memory device 11G and executes the loaded programs, thereby implementing functions as the request module 30A, the acquisition module 30B, the self-position estimation module 30C, the map matching module 30D, the route generation module 30E, the parking section selection module 30F, the guidance information generation module 30G, the screen generation module 30H, the screen control module 30I, the parking detection module 30J, the accumulation module 30K, and the control module 30L. The program executed in the navigation device 30 is an example of an information presentation program.

As an example, the CPU 11A of the operation terminal 20 loads various programs stored in the auxiliary storage device 11F into the memory device 11G and executes the loaded programs, thereby implementing functions as the communication module 20A, the destination setting unit 20B, the screen generation module 20C, the screen control module 20D, the control module 20E, the accumulation module 20F, and the reception module 20G. The program executed in the operation terminal 20 is an example of an information presentation program.

As an example, the CPU 11A of the WEB server 50 loads various programs stored in the auxiliary storage device 11F into the memory device 11G and executes the loaded programs, thereby implementing functions as the communication module 50A, the processing module 50B, and the accumulation module 50C.

As an example, the CPU 11A of the navigation server 60 loads various programs stored in the auxiliary storage device 11F into the memory device 11G and executes the loaded programs, thereby implementing functions as the communication module 60A, the DB module 60B, the accumulation module 60C, the collation module 60D, and the processing module 60E.

As an example, the CPU 11A of the recognition server 70 loads various programs stored in the auxiliary storage device 11F into the memory device 11G and executes the loaded programs, thereby implementing functions as the communication module 70A, the analysis module 70B, and the determination module 70C.

Note that some or all of the plurality of functional units described above can also be implemented using dedicated hardware such as an application specific integrated circuit (ASIC) or a field-programmable gate array (FPGA).

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information providing method executed in a parking lot management system including a management server that communicates with operation terminals of users and manages information related to a vehicle status in a parking lot, the method comprising:
acquiring a first image captured by a first camera configured to capture an entrance of the parking lot and position/operation information indicating positions and operations of vehicles present in the parking lot;
specifying, among the vehicles, an inbound vehicle moving to a parking section provided in the parking lot based on the first image; and
transmitting, based on a position of the inbound vehicle and vacancy information of the parking section specified based on the position/operation information, first navigation information necessary for guiding a route to the parking section in a vacant state to an operation terminal of a user associated with registration information of a vehicle specified as the inbound vehicle among the operation terminals of the users.

2. An information providing method executed in a parking lot management system including a management server that communicates with operation terminals of users and manages information related to a vehicle status in a parking lot, the method comprising:
acquiring position/operation information indicating positions and operations of vehicles present in the parking lot;
specifying, based on the position/operation information, an outbound vehicle moving to an exit of the parking lot from a parking section provided in the parking lot, among the vehicles; and
transmitting, based on a position of the outbound vehicle and an exit position in the parking lot specified based on the position/operation information, second navigation information necessary for guiding a route to the exit position to an operation terminal of a user associated with registration information of a vehicle specified as the outbound vehicle among the operation terminals of the users.

3. The information providing method according to claim 1, further comprising:
specifying, based on the position/operation information, a parked vehicle parked in the parking section among the vehicles; and
changing the vacancy information of the parking section corresponding to a position of the parked vehicle from the vacant state to a parked state.

4. The information providing method according to claim 1, further comprising:
transmitting the first navigation information including the vacancy information and positions and operations of other vehicles present in the parking lot among the vehicles, which are specified based on the position/operation information.

5. The information providing method according to claim 2, further comprising:
calculating, based on the exit position and positions of outbound vehicles specified based on the position/operation information, a number of outbound vehicles present around the exit position among the vehicles; and
transmitting the second navigation information including exit position information indicating the exit position and the calculated number of the outbound vehicles.

6. The information providing method according to claim 5, further comprising:
calculating, when there are a plurality of exits of the parking lot, the number of the outbound vehicles for each exit of the parking lot.

7. The information providing method according to claim 1, further comprising:
acquiring the position/operation information of each vehicle present in the parking lot from a second image captured by a second camera configured to capture each position of the parking lot.

8. The information providing method according to claim 1, further comprising:
acquiring the position/operation information of the vehicles from sensing results of sensors mounted on the respective vehicles.

9. An information display method executed in an operation terminal of a user, which includes a display device and is capable of communicating with a parking lot management system including a management server that manages information related to a vehicle status in a parking lot, the method comprising:
receiving, from the parking lot management system, first navigation information necessary for guiding a route to a parking section in a vacant state, the first navigation information being transmitted when a vehicle corresponding to registration information of the vehicle associated with the operation terminal of the user is specified as an inbound vehicle moving to the parking section provided in the parking lot in the parking lot management system; and
causing a display device to display an image for guiding the route to the parking section in the vacant state based on the first navigation information.

10. An information display method executed in an operation terminal of a user, which includes a display device and is capable of communicating with a parking lot management system including a management server that manages information related to a vehicle status in a parking lot, the method comprising:
receiving, from the parking lot management system, second navigation information necessary for guiding a route to an exit position of the parking lot, the second navigation information being transmitted when a vehicle corresponding to registration information of the vehicle associated with the operation terminal of the user is specified as an outbound vehicle moving to an exit of the parking lot from a parking section provided in the parking lot in the parking lot management system; and
causing a display device to display an image for guiding the route to the exit position based on the second navigation information.

11. The information display method according to claim 9, further comprising:
receiving, from the parking lot management system, the first navigation information including positions and operations of vehicles present in the parking lot and vacancy information of the parking section; and
causing the display device to display an image indicating the positions and the operations of the vehicles on a map of the parking lot indicating whether each of parking sections is in a vacant state or a parked state based on the first navigation information.

12. The information display method according to claim 10, further comprising:
receiving, from the parking lot management system, the second navigation information including a number of outbound vehicles present around the exit position and an exit peripheral image indicating a state around the exit position; and
causing the display device to display an image indicating the number of the outbound vehicles present around the exit position and the exit periphery image.

13. The information display method according to claim 10, further comprising:
acquiring a position of an own vehicle from the own vehicle or the parking lot management system; and
displaying the own vehicle and another vehicle in a distinguishable manner based on the acquired position of the own vehicle.

14. The information display method according to claim 11, further comprising:
acquiring a position of an own vehicle from the own vehicle or the parking lot management system; and
displaying the own vehicle and another vehicle in a distinguishable manner based on the acquired position of the own vehicle.

15. The information display method according to claim 12, further comprising:
acquiring a position of an own vehicle from the own vehicle or the parking lot management system; and
displaying the own vehicle and another vehicle in a distinguishable manner based on the acquired position of the own vehicle.

16. A computer program product including programmed instructions embodied in and stored on a non-transitory computer readable medium, wherein the instructions, when executed by a computer in a parking lot management system including a management server that communicates with operation terminals of users and manages information related to a vehicle status in a parking lot, cause the computer to perform:
acquiring a first image captured by a first camera configured to capture an entrance of the parking lot and position/operation information indicating positions and operations of vehicles present in the parking lot;
specifying, among the vehicles, an inbound vehicle moving to a parking section provided in the parking lot based on the first image; and
transmitting, based on a position of the inbound vehicle and vacancy information of the parking section specified based on the position/operation information, first navigation information necessary for guiding a route to the parking section in a vacant state to an operation terminal of a user associated with registration information of a vehicle specified as the inbound vehicle among the operation terminals of the users.

17. A computer program product including programmed instructions embodied in and stored on a non-transitory computer readable medium, wherein the instructions, when executed by a computer in a parking lot management system including a management server that communicates with operation terminals of users and manages information related to a vehicle status in a parking lot, cause the computer to perform:
acquiring position/operation information indicating positions and operations of vehicles present in the parking lot;
specifying, based on the position/operation information, an outbound vehicle moving to an exit of the parking lot from a parking section provided in the parking lot, among the vehicles; and
transmitting, based on a position of the outbound vehicle and an exit position in the parking lot specified based on the position/operation information, second navigation information necessary for guiding a route to the exit position to an operation terminal of a user associated with registration information of a vehicle specified as the outbound vehicle among the operation terminals of the users.

18. A computer program product including programmed instructions embodied in and stored on a non-transitory computer readable medium, wherein the instructions, when executed by a computer in an operation terminal of a user that is capable of communicating with a parking lot management system including a management server that manages information related to a vehicle status in a parking lot, cause the computer to perform:
receiving, from the parking lot management system, first navigation information necessary for guiding a route to a parking section in a vacant state, the first navigation information being transmitted when a vehicle corresponding to registration information of the vehicle associated with the operation terminal of the user is specified as an inbound vehicle moving to the parking section provided in the parking lot in the parking lot management system; and
causing a display device to display an image for guiding the route to the parking section in the vacant state based on the first navigation information.

19. A computer program product including programmed instructions embodied in and stored on a non-transitory computer readable medium, wherein the instructions, when executed by a computer in an operation terminal of a user that is capable of communicating with a parking lot management system including a management server that manages information related to a vehicle status in a parking lot, cause the computer to perform:
receiving, from the parking lot management system, second navigation information necessary for guiding a route to an exit position of the parking lot, the second navigation information being transmitted when a vehicle corresponding to registration information of the vehicle associated with the operation terminal of the user is specified as an outbound vehicle moving to an exit of the parking lot from a parking section provided in the parking lot in the parking lot management system; and
causing a display device to display an image for guiding the route to the exit position based on the second navigation information.
